(19) United States
(12) Patent Application Publication
(10) Pub. No.: US 2025/0206945 A1
(43) Pub. Date: Jun. 26, 2025

(54) Polycarbonate Compositions Having a High CTI

(71) Applicant: Covestro Deutschland AG, Leverkusen (DE)

(72) Inventors: Tim Hungerland, Köln (DE); Marius Nolte, Köln (DE); Matthias Knaupp, Langenfeld (DE)

(21) Appl. No.: 18/850,124

(22) PCT Filed: Mar. 20, 2023
(86) PCT No.: PCT/EP2023/057006

§ 371 Date: Sep. 24, 2024

(30) Foreign Application Priority Data
Mar. 25, 2022 (EP) 22164390.1

(51) Int. Cl. C08L 69/00; C08K 5/526; C08K 5/5399

(52) U.S. Cl. CPC C08L 69/00; C08K 5/526; C08K 5/5399; C08L 2201/02; C08L 2203/20; C08L 2203/30; C08L 2205/025; C08L 2205/035

(57) ABSTRACT

Described are thermoplastic compositions on the basis of aromatic polycarbonate having a high comparative tracking index, good flame retardancy and a high heat deflection temperature. The compositions contain a combination of (meth)acrylate copolymer, phosphorus-containing flame retardant and fluorine-containing anti-dripping agent.

### CROSS-REFERENCE TO RELATED APPLICATIONS

This application is the United States national phase of International Patent Application No. PCT/EP2023/057006 filed Mar. 20, 2023, and claims priority to European Patent Application No. 22164390.1 filed Mar. 25, 2022, the disclosures of which are hereby incorporated by reference in their entireties.

### BACKGROUND

### Technical Field

The invention relates to flame-retardant thermoplastic compositions based on polycarbonate having high comparative tracking index.

### Description of Related Art

On account of its high impact strength, high heat distortion resistance and a certain inherent flame retardancy, polycarbonate offers many advantages over other thermoplastic polymers. Due to this unique profile of properties, polycarbonate compositions are suitable for a variety of different applications, for example in the field of electrical and electronic components. In particular, good insulation properties and high flame retardancy are essential safety-relevant basic requirements for materials used in this area. In applications in which the plastic is in direct contact with the electrical conductor paths, a high resistance to tracking currents under voltage load is a prerequisite, in order for there not to be any short circuits within the component and hence a fire.

The comparative tracking index (CTI) describes in general the resistance of a plastics material to environmental influences. The CTI value is a measure of the inclination of a plastic, under environmental influences, such as moisture and soiling, to form under voltage electrically conductive paths on the surface and promote resulting electrical tracking currents. The higher the tracking current resistance or the comparative tracking index (CTI value) of a material, the better suited it is for use in high-voltage applications, for example in modern-day electromobility applications. Another advantage of materials having a high CTI value is the possibility of placing electrical conductor paths in an electronic component closer together without risking a short circuit, which in turn enables the reduction of component dimensions and thus more compact designs and weight savings.

In contrast to other thermoplastic polymers such as polystyrene, polyester, etc., polycarbonate itself has a very low comparative tracking index with moderate flame retardancy. Due to the high proportion of aromatic structures, polycarbonate has a rather high tendency to carbonize. The CTI of pure polycarbonate is about 250 V or even lower (F. Acquasanta et al., Polymer Degradation and Stability, 96 (2011), 2098-2103). However, for numerous applications in the electronics/electricals (EE) sector, for example in the electromobility sector, safety grounds require a high CTI, typically of 600 V (corresponding to insulating material group PLC 0 according to EN 50124), of the materials used. At the same time, the materials must have a high flame retardancy, i.e. a V0 classification according to UL 94V, especially even at thin wall thicknesses.

Although pure polycarbonate typically already has a certain intrinsic flame retardancy (V2 classification according to UL 94 V), this is not sufficient for most applications in the EE sector. In order to achieve the required V0 classification according to UL94V, the addition of suitable flame retardants is required. Typically employed for polycarbonate are halogenated sulfonates (e.g. Rimar salt (potassium perfluorobutanesulfonate, C4 salt) or KSS salt (potassium diphenylsulfone 3-sulfonate)) or also organic phosphates (e.g. bisphenol A bis(diphenyl phosphate) (BDP), resorcinol bis(diphenyl phosphate) (RDP)) or phosphazenes. The mechanism of action of these flame retardants is based on the formation of a solid, carbonized surface layer that interrupts the oxygen supply and thus inhibits the combustion process.

The effect forming the basis for good comparative tracking index is, inter alia, a low tendency to form conductive paths on the surface. This is in direct contrast to the mechanism of action, the “charring”, of surface-active flame retardants and thus poses a particular challenge in the reconciling of CTI and flame retardancy.

### SUMMARY

The object was therefore that of providing polycarbonate-based compositions that achieve a UL94 V0 classification at 2 mm, particularly preferably at 1.5 mm, and also have a high comparative tracking index of at least 400 V, preferably of 600 V, preferably determined according to the rapid test method based on IEC 60112:2009. Due to the area of application and the heat development in EE components, the compositions should preferably also have a good heat distortion resistance, in particular a Vicat softening temperature, determined according to ISO 306:2014-3, VST Method B, of at least 105° C., particularly preferably of at least 108° C. Furthermore, the CTI should preferably be robust, i.e. the high CTI should be reliably attained at different operating voltages, not just for instance at 600 V, but also at 300 V or 350 V. Surprisingly, it has been found that this profile of properties is achieved by specific combinations of aromatic polycarbonate with (meth)acrylate copolymer in combination with phosphorus-containing flame retardant and with fluorine-containing anti-drip agent in certain amounts.

### DETAILED DESCRIPTION

The invention thus provides a thermoplastic composition, containing
A) at least 68% by weight of aromatic polycarbonate,
B) 4% by weight to 25% by weight of (meth)acrylate copolymer, wherein the (meth)acrylate copolymer comprises aromatic (meth)acrylate units b1 and methyl methacrylate units b2 in a weight ratio b1/b2 of (5% to 20% by weight)/(80% to 95% by weight), based on the total weight of the (meth)acrylate copolymer,
C) 2% by weight to 10% by weight of phosphorus-containing flame retardant,
D) 0.25% by weight to 2% by weight of fluorine-containing anti-drip agent containing polytetrafluoroethylene,
E) optionally one or more further additives, selected from the group consisting of one or more mold-release agents, heat stabilizers, antioxidants, dyes, pigments, UV absorbers, IR absorbers, impact modifiers, antistats, optical brighteners, hydrolysis stabilizers, transesterification stabilizers, compatibilizers, additives for laser marking, and mixtures thereof,
wherein the % by weight figures, unless stated otherwise, are based on the overall composition and
wherein the ratio of the amount of (meth)acrylate copolymer in % by weight and the amount of phosphorus-containing flame retardant in % by weight is ≤2.5 and the ratio of the amount of (meth)acrylate copolymer in % by weight and the amount of polytetrafluoroethylene in % by weight is ≤20 and
wherein the thermoplastic composition is free of flame retardants selected from the group of alkali metal, alkaline earth metal and ammonium salts of aliphatic or aromatic sulfonic acid, sulfonamide and sulfonimide derivatives.

It will be appreciated that all of the components present in the composition according to the invention sum to 100% by weight. Where a numerical range has its upper limit indicated by “to X”, this includes the numerical value specified and its upward rounding range.

The total amount of (meth)acrylate copolymer in the composition according to the invention is 4% to 25% by weight.

It will be appreciated that the components used may contain typical impurities arising for example from their production processes. It is preferable to use the purest possible components. It will further be appreciated that these impurities may also be present in the event of the exhaustive formulation of the composition.

The invention also provides moldings, produced from the thermoplastic compositions according to the invention, i.e. moldings consisting of a thermoplastic composition according to the invention or comprising a region made from a thermoplastic composition according to the invention. Such moldings are in particular those in which the aforementioned profile of properties is particularly attractive, i.e. moldings which are parts of components from the EE sector, in particular of high-voltage switches, inverters, relays, electronic connectors, electrical connectors, circuit breakers, components for photovoltaic applications, electric motors, heat sinks, chargers and charging plugs for electric vehicles, electrical junction boxes, smart meter housings, miniature circuit breakers, busbars. The component is preferably designed for an operating voltage of at least 400 V. To this end, the material advantageously used preferably has a comparative tracking index of at least 600 V, determined as described above according to the rapid test method based on IEC 60112:2009.

The compositions according to the invention exhibit no significant tracking current (>0.5 A over 2 s) when at least 50 drops of a 0.1% ammonium chloride solution are applied at 375 V, further preferably at 400 V, particularly preferably at 600 V, with the test preferably being carried out according to the rapid test method based on IEC 60112:2009 and described in the description part. At the same time, the compositions according to the invention have a flame retardancy V0 according to UL 94 V at thicknesses of the test specimens of 2 mm. In addition to the high CTI and the good flame retardancy, the compositions preferably also have a good heat distortion resistance, which is manifested in a Vicat softening temperature, determined according to ISO 306:2014-3, VST Method B, of at least 105° C., further preferably at least 110° C.±2° C.

The invention therefore also provides for the use of 4% by weight to 25% by weight, preferably 5% by weight to 25% by weight, of (meth)acrylate copolymer, wherein the (meth)acrylate copolymer comprises aromatic (meth)acrylate units b1 and methyl methacrylate units b2 in a weight ratio b1/b2 of (5% to 20% by weight)/(80% to 95% by weight), based on the total weight of the (meth)acrylate copolymer, 2% by weight to 10% by weight of phosphorus-containing flame retardant, 0.25% by weight to 2% by weight of fluorine-containing anti-drip agent containing polytetrafluoroethylene, wherein the % by weight figures are based on the resulting overall composition, for attaining a high CTI of 600 V and a UL94 V0 classification at a test specimen thickness of 2 mm, in a thermoplastic composition based on aromatic polycarbonate, in particular based on bisphenol A homopolycarbonate. The proportion of aromatic polycarbonate, preferably bisphenol A homopolycarbonate, in the resulting overall composition here is preferably at least 68% by weight and the ratio of the amount of (meth)acrylate copolymer in % by weight and the amount of phosphorus-containing flame retardant in % by weight is ≤2.5 and the ratio of the amount of (meth)acrylate copolymer in % by weight and the amount of polytetrafluoroethylene in % by weight is ≤20.

Such a specific use also exists, for example, when a corresponding composition is used for an insulation layer which, because of the application, requires a CTI of 600 V. Such an insulation layer can for example be provided on an inverter as a layer to protect against external influences. For inverters, standard insulation materials are those having a CTI of 600 V. The composition according to the invention may also be used as an insulation layer for other electrical components, for example transistors. The electrical components of a transistor are protected by overmolding with a plastic having high CTI. The plastic protects the electrical components both from contact and from unwanted electrical interaction with adjoining metallic components—such as a metallic heat sink—or electrical components.

Transistors are also frequently applied directly to a heat sink because of the high evolution of heat in operation. Here too, the thermoplastic composition according to the invention introduced between heat sink and transistor ensures safe operation.

A further field of use is that of mounting brackets for busbars, where it is likewise necessary to use materials having a high CTI. The mounting brackets have essentially two functions: fixing of the busbars in the assembly group in order to prevent any change in position in operation, and action as spacers, in order to be able to run several busbars in parallel, where it is necessary here too for a sufficiently large distance to be chosen between the two busbars to prevent sparkover through air. In addition, however, tracking on the surface of the mounting bracket must be prevented between the busbars, but also between the busbar and other metallic components, for example the screws for securing the mounting brackets on the structure beneath. Mounting brackets having a high CTI can increase component density and energy density here.

In the case of plug connectors, plug devices and sockets, there is a high risk of tracking current formation that can lead to electrical failure and possible fire. A housing that seals current-carrying wires can improve the situation, since the risk of soiling is low. Plug connectors for chargers or else USB-C plug connectors have an elevated risk since the current-carrying conductor tracks cannot be covered or sealed and, moreover, are exposed to soiling such as perspiration, moisture, fabric particles, dust and other materials. A high-CTI material is needed to offer sufficient protection from tracking, but also in order to enable miniaturization or an increase in power density.

Of course, the features mentioned as preferred, particularly preferred, and so on, for the composition also apply with regard to the use according to the invention.

The individual constituents of the compositions according to the invention are more particularly elucidated hereinbelow:

### Component A

Component A of the compositions according to the invention are aromatic polycarbonates.

Aromatic polycarbonates in the context of the present invention include not only homopolycarbonates but also copolycarbonates and/or polyestercarbonates; the polycarbonates may be linear or branched in a known manner. Mixtures of polycarbonates may also be used according to the invention.

The thermoplastic polycarbonates, including the thermoplastic aromatic polyestercarbonates, preferably have weight-average molecular weights M_{w} of 15 000 g/mol to 40 000 g/mol, further preferably to 34 000 g/mol, particularly preferably of 17 000 g/mol to 33 000 g/mol, in particular of 19 000 g/mol to 32 000 g/mol, determined by gel permeation chromatography, calibrated against bisphenol A polycarbonate standards using dichloromethane as eluent, calibration with linear polycarbonates (formed from bisphenol A and phosgene) of known molar mass distribution from PSS Polymer Standards Service GmbH, Germany, and calibration by method 2301-0257502-09D (2009 German-language edition) from Currenta GmbH & Co. OHG, Leverkusen. The eluent is dichloromethane. Column combination of crosslinked styrene-divinylbenzene resins. Diameter of the analytical columns: 7.5 mm; length: 300 mm. Particle sizes of the column material: 3 μm to 20 μm. Concentration of the solutions: 0.2% by weight. Flow rate: 1.0 ml/min, temperature of solutions: 30° C. Use of UV and/or RI detection.

The melt volume flow rate MVR of the aromatic polycarbonate used, determined according to ISO 1133:2012-03, at a test temperature of 300° C. and with 1.2 kg load, is preferably 5 to 35 cm³/(10 min), further preferably 6 cm³/(10 min) to 25 cm³/(10 min), further preferably still 6 to 21 cm³/(10 min).

A portion of up to 80 mol %, preferably of 20 mol % to 50 mol %, of the carbonate groups in the polycarbonates used according to the invention may be replaced by aromatic dicarboxylic ester groups. Polycarbonates of this type that have not only acid radicals derived from carbonic acid but also acid radicals derived from aromatic dicarboxylic acids incorporated into the molecular chain are referred to as aromatic polyestercarbonates. For the purposes of the present invention, they are subsumed within the umbrella term “thermoplastic aromatic polycarbonates”.

Details of the preparation of polycarbonates have been set out in many patent specifications over the past 40 years or so. Reference may be made here by way of example to Schnell, “Chemistry and Physics of Polycarbonates”, Polymer Reviews, Volume 9, Interscience Publishers, New York, London, Sydney 1964, to D. Freitag, U. Grigo, P. R. Müller, H. Nouvertné, BAYER AG, “Polycarbonates” in Encyclopedia of Polymer Science and Engineering, Volume 11, Second Edition, 1988, pages 648-718 and finally to U. Grigo, K. Kirchner and P. R. Müller “Polycarbonate” [Polycarbonates] in Becker/Braun, Kunststoff-Handbuch [Plastics Handbook], volume 3/1, Polycarbonate, Polyacetale, Polyester, Celluloseester [Polycarbonates, Polyacetals, Polyesters, Cellulose Esters], Carl Hanser Verlag Munich, Vienna 1992, pages 117 to 299.

Aromatic polycarbonates are prepared, for example, by reaction of dihydroxyaryl compounds with carbonyl halides, preferably phosgene, and/or with aromatic dicarbonyl dihalides, preferably benzenedicarbonyl dihalides, by the interfacial process, optionally with use of chain terminators and optionally with use of trifunctional or more than trifunctional branching agents. Likewise possible is preparation via a melt polymerization process, by reacting dihydroxyaryl compounds with, for example, diphenyl carbonate.

For the preparation of the polyestercarbonates, a portion of the carbonic acid derivatives is replaced by aromatic dicarboxylic acids or derivatives of the dicarboxylic acids, and specifically with aromatic dicarboxylic ester structural units according to the carbonate structural units to be replaced in the aromatic polycarbonates.

Dihydroxyaryl compounds suitable for the preparation of polycarbonates are those of formula (1)

HO—Z—OH (1),

in which
Z is an aromatic radical which has 6 to 30 carbon atoms, may contain one or more aromatic rings, may be substituted and may contain aliphatic or cycloaliphatic radicals or alkylaryls or heteroatoms as bridging elements.

It is preferable for Z in formula (1) to be a radical of formula (2)

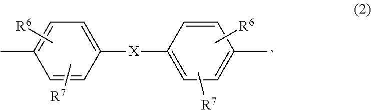

in which
R⁶ and R⁷ are independently H, C₁- to C₁₈-alkyl, C₁- to C₁₈-alkoxy, halogen such as Cl or Br or in each case optionally substituted aryl or aralkyl, preferably H or C₁- to C₁₂-alkyl, particularly preferably H or C₁- to C₈-alkyl and very particularly preferably H or methyl, and
X is a single bond, —SO₂—, —CO—, —O—, —S—, C₁- to C₆-alkylene, C₂- to C₅-alkylidene or C₅- to C₆-cycloalkylidene which may be substituted by C₁- to C₆-alkyl, preferably methyl or ethyl, or else C₆- to C₁₂-arylene which may optionally be fused to further aromatic rings containing heteroatoms.
X is preferably a single bond, C₁- to C₅-alkylene, C₂- to C₅-alkylidene, C₅- to C₆-cycloalkylidene, —O—, —SO—, —CO—, —S—, —SO₂—
or a radical of formula (3)

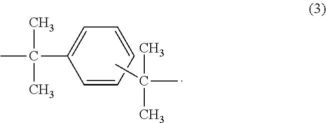

Examples of dihydroxyaryl compounds are: dihydroxybenzenes, dihydroxydiphenyls, bis(hydroxyphenyl)alkanes, bis(hydroxyphenyl)cycloalkanes, bis(hydroxyphenyl)aryls, bis(hydroxyphenyl) ethers, bis(hydroxyphenyl) ketones, bis(hydroxyphenyl) sulfides, bis(hydroxyphenyl) sulfones, bis(hydroxyphenyl) sulfoxides, 1,1′-bis(hydroxyphenyl)diisopropylbenzenes and the ring-alkylated and ring-halogenated compounds thereof.

Dihydroxyaryl compounds suitable for the preparation of polycarbonates are for example hydroquinone, resorcinol, dihydroxydiphenyls, bis(hydroxyphenyl)alkanes, bis(hydroxyphenyl)cycloalkanes, bis(hydroxyphenyl) sulfides, bis(hydroxyphenyl) ethers, bis(hydroxyphenyl) ketones, bis(hydroxyphenyl) sulfones, bis(hydroxyphenyl) sulfoxides, α,α′-bis(hydroxyphenyl)diisopropylbenzenes, phthalimidines derived from derivatives of isatin or phenolphthalein, and the ring-alkylated, ring-arylated and ring-halogenated compounds thereof.

Preferred dihydroxyaryl compounds are 4,4′-dihydroxydiphenyl, 2,2-bis(4-hydroxyphenyl)propane (bisphenol A), 2,4-bis(4-hydroxyphenyl)-2-methylbutane, 1,1-bis(4-hydroxyphenyl)-p-diisopropylbenzene, 2,2-bis(3-methyl-4-hydroxyphenyl)propane, dimethylbisphenol A, bis(3,5-dimethyl-4-hydroxyphenyl)methane, 2,2-bis(3,5-dimethyl-4-hydroxyphenyl)propane, bis(3,5-dimethyl-4-hydroxyphenyl) sulfone, 2,4-bis(3,5-dimethyl-4-hydroxyphenyl)-2-methylbutane, 1,1-bis(3,5-dimethyl-4-hydroxyphenyl)-p-diisopropylbenzene and 1,1-bis(4-hydroxyphenyl)-3,3,5-trimethylcyclohexane and also the dihydroxyaryl compounds (I) to (III)

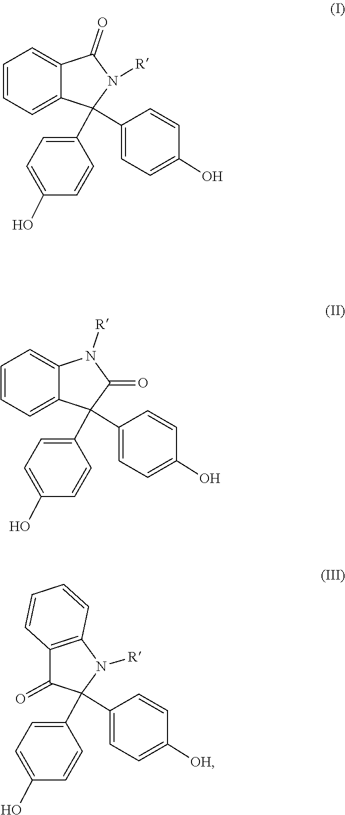

in which each R′ is a C₁- to C₄-alkyl radical, aralkyl radical or aryl radical, preferably a methyl radical or phenyl radical, very particularly preferably a methyl radical.

Particularly preferred dihydroxyaryl compounds are 2,2-bis(4-hydroxyphenyl)propane (bisphenol A), 2,2-bis(3,5-dimethyl-4-hydroxyphenyl)propane, 1,1-bis(4-hydroxyphenyl)cyclohexane, 1,1-bis(4-hydroxyphenyl)-3,3,5-trimethylcyclohexane, 4,4′-dihydroxydiphenyl and dimethylbisphenol A, and also the bisphenols of formulae (I), (II) and (III).

These and other suitable dihydroxyaryl compounds are described by way of example in U.S. Pat. Nos. 3,028,635 A, 2,999,835 A, 3,148,172 A, 2,991,273 A, 3,271,367 A, 4,982,014 A and 2,999,846 A, in DE 1 570 703 A, DE 2063 050 A, DE 2 036 052 A, DE 2 211 956 A and DE 3 832 396 A, in FR 1 561 518 A, in the monograph “H. Schnell, Chemistry and Physics of Polycarbonates, Interscience Publishers, New York 1964”, and in JP 62039/1986 A, JP 62040/1986 A and JP 105550/1986 A.

In the case of the homopolycarbonates, only one dihydroxyaryl compound is used; in the case of the copolycarbonates, two or more dihydroxyaryl compounds are used.

Examples of suitable carbonic acid derivatives include phosgene or diphenyl carbonate.

Suitable chain terminators that may be used in the preparation of the polycarbonates are monophenols. Examples of suitable monophenols include phenol itself, alkylphenols such as cresols, p-tert-butylphenol, cumylphenol, and mixtures thereof.

Preferred chain terminators are the phenols which have substitution by one or more linear or branched, preferably unsubstituted, C₁- to C₃₀-alkyl radicals, or by tert-butyl. Particularly preferred chain terminators are phenol, cumylphenol and/or p-tert-butylphenol.

The amount of chain terminator to be used is preferably 0.1 to 5 mol %, based on moles of dihydroxyaryl compounds used in each case. The chain terminators may be added before, during or after the reaction with a carbonic acid derivative.

Suitable branching agents are the trifunctional or more than trifunctional compounds known in polycarbonate chemistry, in particular those having three or more than three phenolic OH groups.

Examples of suitable branching agents include 1,3,5-tri (4-hydroxyphenyl)benzene, 1,1,1-tri (4-hydroxyphenyl)ethane, tri (4-hydroxyphenyl)phenylmethane, 2,4-bis(4-hydroxyphenylisopropyl)phenol, 2,6-bis(2-hydroxy-5′-methylbenzyl)-4-methylphenol, 2-(4-hydroxyphenyl)-2-(2,4-dihydroxyphenyl)propane, tetra(4-hydroxyphenyl)methane, tetra(4-(4-hydroxyphenylisopropyl)phenoxy)methane and 1,4-bis((4′,4″-dihydroxytriphenyl)methyl)benzene and 3,3-bis(3-methyl-4-hydroxyphenyl)-2-oxo-2,3-dihydroindole.

The amount of any branching agents to be used is preferably 0.05 mol % to 2.00 mol %, based on moles of dihydroxyaryl compounds used in each case.

The branching agents can either form an initial charge with the dihydroxyaryl compounds and the chain terminators in the aqueous alkaline phase or can be added, dissolved in an organic solvent, before the phosgenation. In the case of the transesterification method, the branching agents are used together with the dihydroxyaryl compounds.

Particularly preferred polycarbonates are the homopolycarbonate based on bisphenol A, the homopolycarbonate based on 1,1-bis(4-hydroxyphenyl)-3,3,5-trimethylcyclohexane and the copolycarbonates based on the two monomers bisphenol A and 1,1-bis(4-hydroxyphenyl)-3,3,5-trimethylcyclohexane or the two monomers bisphenol A and 4,4′-dihydroxydiphenyl, and homo- or copolycarbonates derived from the dihydroxyaryl compounds of formulae (I), (II) and/or (III)

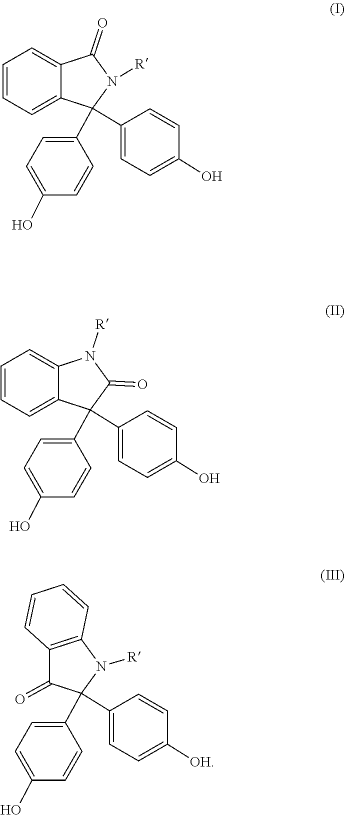

in which each R′ is C₁- to C₄-alkyl, aralkyl or aryl, preferably methyl or phenyl, very particularly preferably methyl,
   especially with bisphenol A. Very particularly preferably, the aromatic polycarbonate comprises a bisphenol A-based homopolycarbonate. Exceptionally preferably, the aromatic polycarbonate is bisphenol A-based homopolycarbonate.

The total proportion of the monomer units based on formulae (I), (II), (III), 4,4′-dihydroxydiphenyl and/or bisphenol TMC in the copolycarbonate, if such a copolycarbonate is used, is preferably 0.1-88 mol %, particularly preferably 1-86 mol %, very particularly preferably 5-84 mol % and in particular 10-82 mol % (based on the sum total of the moles of dihydroxyaryl compounds used).

The relative solution viscosity of the copolycarbonates, determined according to ISO 1628-4:1999, is preferably in the range of 1.15-1.35.

The dihydroxyaryl compounds used, like all the other chemicals and auxiliaries added to the synthesis, may be contaminated with the impurities originating from their own synthesis, handling and storage. It is however desirable to use raw materials of the highest possible purity.

Also preferred are copolycarbonates prepared using diphenols of general formula (4a):

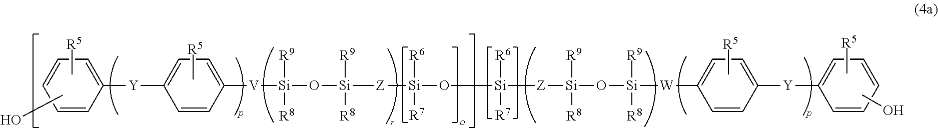

where
R⁵ is hydrogen or C₁- to C₄-alkyl, C₁- to C₃-alkoxy, preferably hydrogen; methoxy or methyl,
R⁶, R⁷, R⁸ and R⁹ are each independently C₁- to C₄-alkyl or C₆- to C₁₂-aryl, preferably methyl or phenyl,
Y is a single bond, SO₂—, —S—, —CO—, —O—, C₁- to C₆-alkylene, C₂- to C₅-alkylidene, C₆- to C₁₂-arylene which may optionally be fused to further aromatic rings containing heteroatoms or is a C₅- to C₆-cycloalkylidene radical which may be mono- or polysubstituted by C₁- to C₄-alkyl, preferably is a single bond, —O—, isopropylidene or a C₅- to C₆-cycloalkylidene radical which may be mono- or polysubstituted by C₁- to C₄-alkyl,
V is oxygen, C₂- to C₆-alkylene or C₃- to C₆-alkylidene, preferably oxygen or C₃-alkylene,
p, q and r are each independently 0 or 1,
when q=0, W is a single bond, when q=1 and r=0, W is oxygen, C₂- to C₆-alkylene or C₃- to C₆-alkylidene, preferably oxygen or C₃-alkylene,
when q=1 and r=1, W and V are each independently C₂- to C₆-alkylene or C₃- to C₆-alkylidene, preferably C₃-alkylene,
Z is a C₁- to C₆-alkylene, preferably C₂-alkylene,
is an average number of repeat units from 10 to 500, preferably 10 to 100, and
m is an average number of repeat units from 1 to 10, preferably 1 to 6, further preferably 1.5 to 5. It is likewise possible to use diphenols in which two or more siloxane blocks of general formula (4a) are joined to one another via terephthalic acid and/or isophthalic acid to form ester groups.

Especially preferred are (poly)siloxanes of formulae (5) and (6)

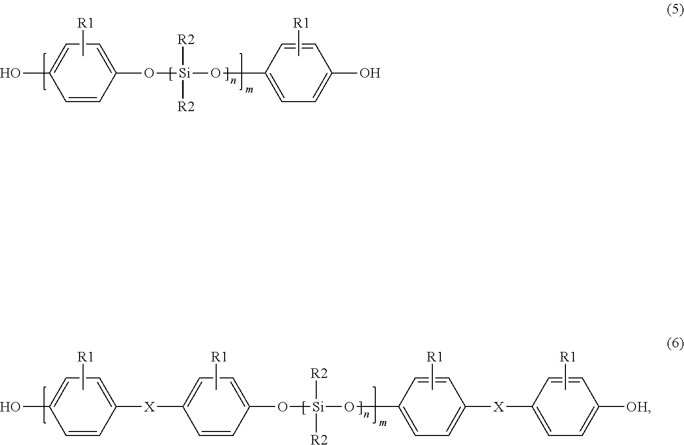

where R¹ is hydrogen, C₁- to C₄-alkyl, preferably hydrogen or methyl and especially preferably hydrogen,
R² is independently aryl or alkyl, preferably methyl,
X is a single bond, —SO₂—, —CO—, —O—, —S—, C₁- to C₆-alkylene, C₂- to C₅-alkylidene or C₆- to C₁₂-arylene which may optionally be fused to further aromatic rings containing heteroatoms,
X is preferably a single bond, C₁- to C₅-alkylene, C₂- to C₅-alkylidene, C₅- to C₁₂-cycloalkylidene, —O—, —SO— —CO—, —S—, —SO₂—, particularly preferably X is a single bond, isopropylidene, C₅- to C₁₂-cycloalkylidene or oxygen, and very particularly preferably is isopropylidene,
n is an average number from 10 to 400, preferably 10 to 100, especially preferably 15 to 50 and
m is an average number from 1 to 10, preferably from 1 to 6 and especially preferably from 1.5 to 5.

The siloxane block may likewise preferably be derived from the following structure

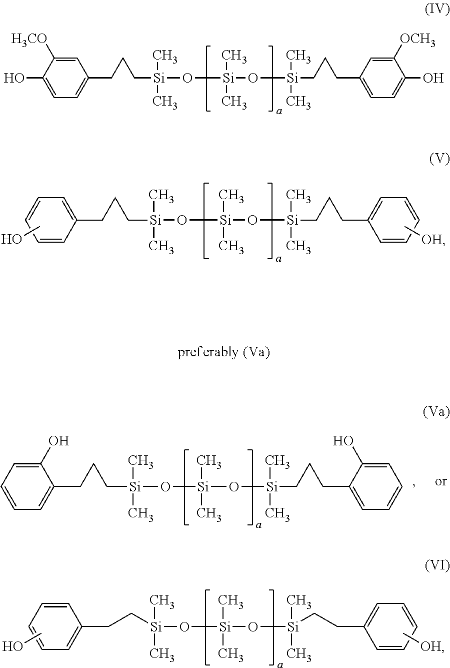

where a in formulae (IV), (V) and (VI) is an average number from 10 to 400, preferably 10 to 100 and particularly preferably 15 to 50.

It is likewise preferable when at least two identical or different siloxane blocks of general formulae (IV), (V) or (VI) are joined to one another via terephthalic acid and/or isophthalic acid to form ester groups.

It is likewise preferable when, in formula (4a), p=0, V is C₃-alkylene, r=1, Z is C₂-alkylene, R⁸ and R⁹ are methyl, q=1, W is C₃-alkylene, m=1, R⁵ is hydrogen or C₁- to C₄-alkyl, preferably hydrogen or methyl, R⁶ and R⁷ are each independently C₁- to C₄-alkyl, preferably methyl, and o is 10 to 500.

Copolycarbonates having monomer units of formula (4a) and in particular also the preparation thereof are described in WO 2015/052106 A2.

Copolycarbonates having monomer units of formula (IV) and in particular also the preparation thereof are described in WO 2015/052106 A2.

Examples of aromatic dicarboxylic acids that are suitable for the preparation of the polyestercarbonates include orthophthalic acid, terephthalic acid, isophthalic acid, tert-butylisophthalic acid, 3,3′-diphenyldicarboxylic acid, 4,4′-diphenyldicarboxylic acid, 4,4-benzophenonedicarboxylic acid, 3,4′-benzophenonedicarboxylic acid, 4,4′-diphenyl ether dicarboxylic acid, 4,4′-diphenylsulfonedicarboxylic acid, 2,2-bis(4-carboxyphenyl)propane, trimethyl-3-phenylindane-4,5′-dicarboxylic acid.

Among the aromatic dicarboxylic acids, particular preference is given to using terephthalic acid and/or isophthalic acid.

Derivatives of dicarboxylic acids are dicarbonyl dihalides and dialkyl dicarboxylates, especially dicarbonyl dichlorides and dimethyl dicarboxylates.

Replacement of the carbonate groups by the aromatic dicarboxylic ester groups is substantially stoichiometric, and also quantitative, and the molar ratio of the reactants is therefore also maintained in the final polyestercarbonate. The aromatic dicarboxylic ester groups may be incorporated either randomly or in blocks.

The compositions according to the invention contain at least 68% by weight, preferably at least 75% by weight, particularly preferably at least 80% by weight, of aromatic polycarbonate, and are thus based on aromatic polycarbonate. The aromatic polycarbonate according to component A preferably comprises bisphenol A homopolycarbonate. Particularly preferably, the polycarbonate is bisphenol A homopolycarbonate.

### Component B

Component B is (meth)acrylate copolymer. It will be appreciated that this may be only one (meth)acrylate copolymer or a mixture of various (meth)acrylate copolymers. Component B does not include polymers containing polyalkyl(meth)acrylate as part of a graft polymer. The polyalkyl(meth)acrylate is preferably a linear polymer.

The (meth)acrylate copolymer according to component B preferably has a weight-average molecular weight of 5000 to 30 000 g/mol, further preferably 10 000 to 25 000 g/mol, determined by means of gel permeation chromatography in tetrahydrofuran with PMMA calibration.

The stated weight-average molecular weight is based on all of the (meth)acrylate copolymer present in the composition according to the invention, i.e. possibly on a mixture of various (meth)acrylate copolymers.

The (meth)acrylate copolymer comprises aromatic (meth)acrylate units (b1) and also methyl methacrylate units (b2) in a weight ratio (b1/b2) of (5% to 80% by weight)/(20% to 95% by weight), very particularly preferably in a weight ratio (b1/b2) of (5% to 20% by weight)/(80% to 95% by weight), the figures being based on the total weight of the (meth)acrylate copolymer. According to the invention, “(meth)acrylate” means an acrylate or a methacrylate.

Aromatic (meth)acrylate, which forms the units b1, is a (meth)acrylate that bears an aromatic group in its ester group. Such a (meth)acrylate may be used alone or in a mixture with further aromatic (meth)acrylates. Examples of aromatic (meth)acrylates are phenyl (meth)acrylate and benzyl (meth)acrylate, which are preferred aromatic (meth)acrylates according to the invention. Phenyl (meth)acrylate is particularly preferably used for units b1, particularly preferably exclusively.

The units b2 are formed by methyl methacrylate.

The proportion of component B in the compositions according to the invention is 4% by weight to 25% by weight, preferably 5% by weight to 22% by weight, further preferably 5% to 20% by weight, further preferably still to 15% by weight, very particularly preferably 5% by weight to 10% by weight, based on the overall composition.

### Component C

Component C of the compositions according to the invention is phosphorus-containing flame retardants. It may be a single phosphorus-containing flame retardant, but it may also be a mixture of various phosphorus-containing flame retardants.

Preferred phosphorus-containing flame retardants are cyclic phosphazenes, phosphorus compounds of formula (10), and mixtures thereof:

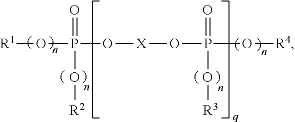

in which
R¹, R², R³ and R⁴ are independently a C₁- to C₈-alkyl radical, in each case optionally halogenated and in each case branched or unbranched, and/or C₅- to C₆-cycloalkyl radical, C₆- to C₂₀-aryl radical or C₇- to C₁₂-aralkyl radical, in each case optionally substituted by branched or unbranched alkyl, and/or halogen, preferably chlorine and/or bromine,
n is independently 0 or 1,
q is a value from 0 to 30 and
X is a mono- or polycyclic aromatic radical having 6 to 30 carbon atoms or a linear or branched aliphatic radical having 2 to 30 carbon atoms, each of which may be substituted or unsubstituted, and bridged or unbridged.

Preferably, R¹, R², R³ and R⁴ are independently branched or unbranched C₁- to C₄-alkyl, phenyl, naphthyl or C₁- to C₄-alkyl-substituted phenyl. In the case of aromatic R¹, R², R³ and/or R⁴ groups, these may in turn be substituted by halogen and/or alkyl groups, preferably chlorine, bromine and/or C₁- to C₄-alkyl, branched or unbranched. Particularly preferred aryl radicals are cresyl, phenyl, xylenyl, propylphenyl or butylphenyl, and also the corresponding brominated and chlorinated derivatives thereof.

X in formula (10) is preferably derived from dihydroxyaryl compounds.

X in formula (10) is particularly preferably

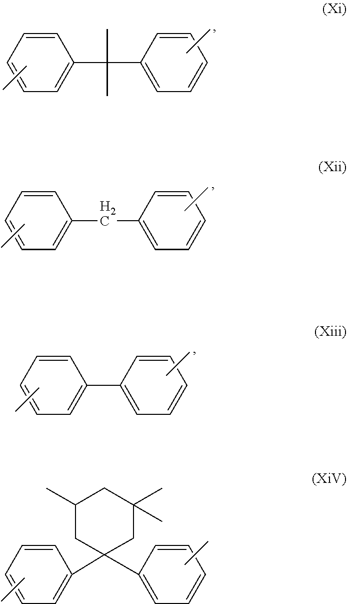

or the chlorinated and/or brominated derivatives thereof. X (together with the adjoining oxygen atoms) is preferably derived from hydroquinone, bisphenol A or diphenylphenol. It is likewise preferable for X to be derived from resorcinol. Particularly preferably, X is derived from bisphenol A. n in formula (10) is preferably equal to 1. q is preferably 0 to 20, particularly preferably 0 to 10, and in the case of mixtures is average values from 0.8 to 5.0, preferably 1.0 to 3.0, further preferably 1.05 to 2.00 and particularly preferably from 1.08 to 1.60.

The phosphorus compound of general formula (10) is preferably a compound of formula (11):

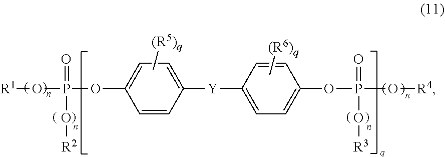

in which
R¹, R², R³ and R⁴ are each independently a linear or branched C₁- to C₈-alkyl radical and/or optionally linear- or branched-alkyl-substituted C₅- to C₆-cycloalkyl radical, C₆- to C₁₀-aryl radical or C₇- to C₁₂-aralkyl radical,
n is independently 0 or 1,
q is independently 0, 1, 2, 3 or 4,
N is a number between 1 and 30,
R₅ and R₆ are independently a linear or branched C₁- to C₄-alkyl radical, preferably methyl radical, and
Y is linear or branched C₁- to C₇-alkylidene, a linear or branched C₁- to C₇-alkylene radical, C₅- to C₁₂-cycloalkylene radical, C₅- to C₁₂-cycloalkylidene radical, —O—, —S—, —SO—, SO₂ or —CO—.

Phosphorus compounds of formula (10) are in particular tributyl phosphate, triphenyl phosphate, tricresyl phosphate, diphenyl cresyl phosphate, diphenyl octyl phosphate, diphenyl 2-ethylcresyl phosphate, tri(isopropylphenyl) phosphate, resorcinol-bridged oligophosphate and bisphenol A-bridged oligophosphate. The use of oligomeric phosphoric esters of formula (10) which are derived from bisphenol A is especially preferred.

Further preference is given to using mixtures of identical structure and different chain length, with the stated q value being the average q value. The average q value is determined by determining the composition of the phosphorus compound mixture (molecular weight distribution) by means of high pressure liquid chromatography (HPLC) at 40° C. in a mixture of acetonitrile and water (50:50) and using this to calculate the average values of q.

Particularly preferably, bisphenol A-based oligophosphate (bisphenol A bis(diphenyl phosphate)) according to formula (12) with q=1 to 20, in particular with q=1.0 to 1.2, is present in the compositions according to the invention.

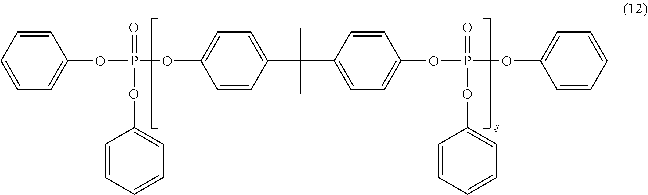

Phosphorus compounds of this kind are known (cf., for example, EP 0 363 608 A1, EP 0 640 655 A2) or can be prepared in an analogous manner by known methods (e.g. Ullmanns Enzyklopädie der technischen Chemie [Ullmann's Encyclopedia of Industrial Chemistry], vol. 18, p. 301 ff., 1979; Houben-Weyl, Methoden der organischen Chemie [Methods of Organic Chemistry], vol. 12/1, p. 43; Beilstein vol. 6, p. 177).

If an organophosphate is used as phosphorus-containing flame retardant, preferably 2% to 8% by weight is used.

Just as preferably as the phosphorus compounds according to formula (10), it is possible to use cyclic phosphazenes according to formula (13) as component C:

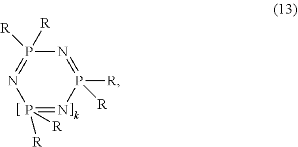

where
R in each case is identical or different and is
   an amine radical,
   an in each case optionally halogenated, preferably fluorine-halogenated, further preferably monohalogenated, C₁- to C₈-alkyl radical, preferably methyl radical, ethyl radical, propyl radical or butyl radical,
   a C₁- to C₈-alkoxy radical, preferably a methoxy radical, ethoxy radical, propoxy radical or butoxy radical,
   an in each case optionally alkyl-substituted, preferably C₁- to C₄-alkyl-substituted, and/or halogen-substituted, preferably chlorine- and/or bromine-substituted, C₅- to C₆-cycloalkyl radical,
   an in each case optionally alkyl-substituted, preferably C₁- to C₄-alkyl-substituted, and/or halogen-substituted, preferably chlorine-, bromine-, and/or hydroxy-substituted, C₆- to C₂₀-aryloxy radical, preferably phenoxy radical, naphthyloxy radical,
   an in each case optionally alkyl-substituted, preferably C₁- to C₄-alkyl-substituted, and/or halogen-substituted, preferably chlorine- and/or bromine-substituted, C₇- to C₁₂-aralkyl radical, preferably phenyl-C₁- to C₄-alkyl radical, or
   a halogen radical, preferably chlorine or fluorine, or
   an OH radical,
k is a whole number from 1 to 10, preferably a number from 1 to 8, particularly preferably 1 to 5, very particularly preferably is 1.

Particularly preferably used according to the invention are commercially available phosphazenes. These are typically mixtures of rings of different ring sizes.

Further preference is given, either individually or in a mixture, to: propoxyphosphazene, phenoxyphosphazene, methylphenoxyphosphazene, aminophosphazene, fluoroalkylphosphazenes, and also phosphazenes having the following structures:

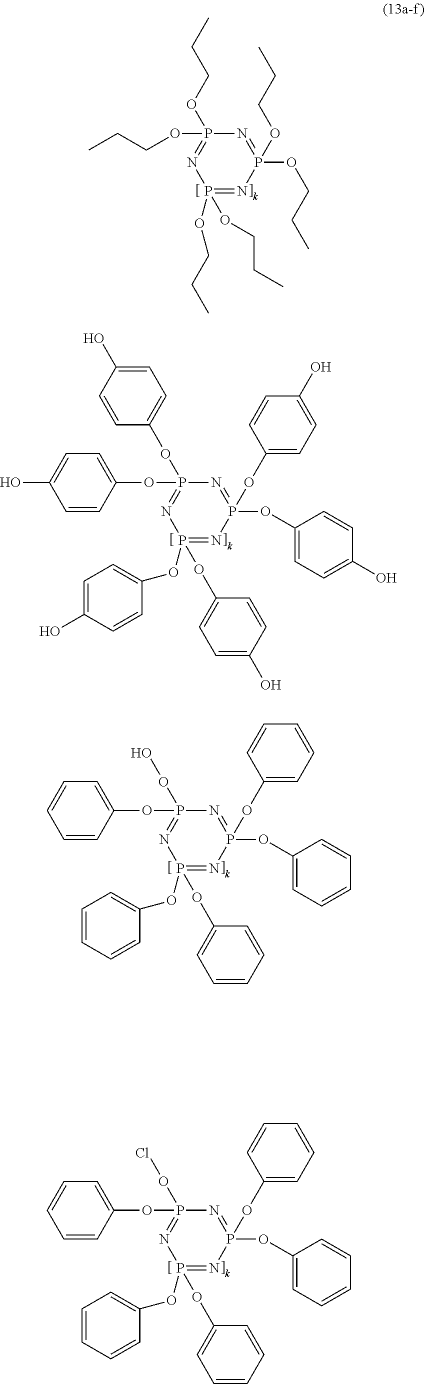

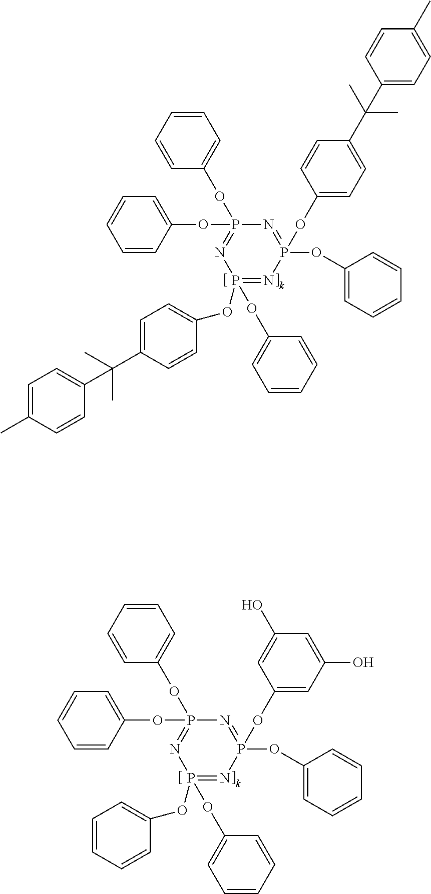

In the compounds 13a-f shown above, k=1, 2 or 3.

Preferably, the proportion of phosphazenes that are halogen-substituted on the phosphorus, for example composed of incompletely reacted starting material, is less than 1000 ppm, further preferably less than 500 ppm.

The phosphazenes can be used alone or in a mixture. The radical R may always be the same or two or more radicals in the formulae may be different. The radicals R of a phosphazene are preferably identical.

In one embodiment, solely phosphazenes having the same R are used.

Preferably, the proportion of tetramers (k=2) is from 2 to 50 mol %, based on component C, further preferably from 5 to 40 mol %, further preferably still from 10 to 30 mol %, particularly preferably from 10 to 22 mol %.

Preferably, the proportion of higher oligomeric phosphazenes (k=3, 4, 5, 6 and 7) is from 0 to 30 mol %, based on component C, further preferably from 2.5 to 25 mol %, further preferably still from 5 to 20 mol %, and particularly preferably from 6-15 mol %.

Preferably, the proportion of oligomers with k≥8 is from 0 to 2.0 mol %, based on component C, and preferably from 0.10 to 1.00 mol %.

Further preferably, the phosphazenes of component C satisfy all three above-mentioned conditions with respect to the proportions of oligomers.

Particularly preferably present as component C is phenoxyphosphazene (all R=phenoxy, formula 13g), alone or with further phosphazenes according to formula (13) as component C, with a proportion of oligomers with k=1 (hexaphenoxyphosphazene) of 50 to 98 mol %, particularly preferably 60 to 72% by weight, based on the amount of phenoxyphosphazene. If phenoxyphosphazene is used, the proportion of oligomers with k=2 is very particularly preferably: 15% to 22% by weight and with k≥3: 10% to 13% by weight.

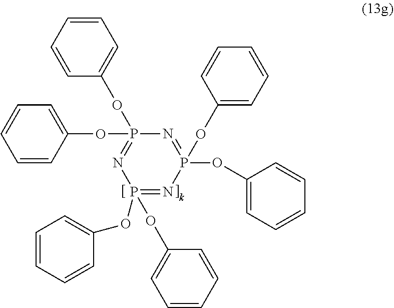 [SMILES: c1ccc(OP2(Oc3ccccc3)=NP(Oc3ccccc3)(Oc3ccccc3)=NP(Oc3ccccc3)(Oc3ccccc3)=N2)cc1]

Alternatively, component C very particularly preferably comprises, and very particularly preferably is, a phenoxyphosphazene having a trimer proportion (k=1) of 70 to 85 mol %, a tetramer proportion (k=2) of 10 to 20 mol %, a proportion of higher oligomeric phosphazenes (k=3, 4, 5, 6 and 7) of 3 to 8 mol % and phosphazene oligomers with k≥8 of 0.1 to 1 mol %, based on component C.

In an alternative preferred embodiment, n, defined as the arithmetic mean of k, is in the range from 1.10 to 1.75, preferably from 1.15 to 1.50, further preferably from 1.20 to 1.45, and particularly preferably from 1.20 to 1.40 (range boundaries included).

$$n = \frac{{\sum }_{i = 1}^{max} {k}_{i} \cdot {x}_{i}}{{\sum }_{i = 1}^{max} {x}_{i}} \qquad ( 14 )$$

Phosphazenes and the preparation thereof are described, for example, in EP 728 811 A2, DE 1961668 A and WO 97/40092 A1.

The oligomer compositions in the respective blend samples can be detected and quantified after compounding by means of ³¹P NMR (chemical shift; δ trimer: 6.5 to 10.0 ppm; δ tetramer: −10 to −13.5 ppm; δ higher oligomers: −16.5 to −25.0 ppm).

If the phosphorus-containing flame retardant is a phosphazene, preferably 2% to 8% by weight, further preferably 4% to 8% by weight, is used.

Very particularly preferably, component C comprises bisphenol A-based oligophosphate according to formula (12) and/or cyclic phosphazene according to formula (13), most preferably component C is bisphenol A-based oligophosphate according to formula (12) and/or cyclic phosphazene according to formula (13).

The proportion of phosphorus-containing flame retardant in the compositions according to the invention is 2% by weight to 10% by weight, preferably 2% by weight to 8% by weight, particularly preferably to 6% by weight, very particularly preferably to ≤5% by weight, exceptionally preferably to 4% by weight, based on the overall composition. The Vicat temperature decreases significantly with increasing proportion of the phosphorus-containing flame retardant.

### Component D

The compositions according to the invention contain as component D a fluorine-containing anti-drip agent containing polytetrafluoroethylene, which may be a mixture of two or more anti-drip agents. The total amount of anti-drip agent (anti-dripping agent) is 0.25% by weight to 2% by weight, preferably 0.4% by weight to 1% by weight, particularly preferably 0.5% by weight to 1.0% by weight of at least one anti-drip agent.

The fluorinated polyolefins used with preference as anti-drip agents have high molecular weight and have glass transition temperatures of above −30° C., generally of above 100° C., and fluorine contents preferably from 65% by weight to 76% by weight, in particular from 70% to 76% by weight. Preferred fluorinated polyolefins are polytetrafluoroethylene, which is present in all cases, polyvinylidene fluoride, tetrafluoroethylene/hexafluoropropylene copolymers and ethylene/tetrafluoroethylene copolymers. Fluorinated polyolefins are known (cf. “Vinyl and Related Polymers” by Schildknecht, John Wiley & Sons, Inc., New York, 1962, pages 484-494; “Fluoropolymers” by Wall, Wiley-Interscience, John Wiley & Sons, Inc., New York, volume 13, 1970, pages 623-654; “Modern Plastics Encyclopedia”, 1970-1971, volume 47, No. 10 A, October 1970, McGraw-Hill, Inc., New York, pages 134 and 774; “Modern Plastics Encyclopedia”, 1975-1976, October 1975, volume 52, No. 10 A, McGraw-Hill, Inc., New York, pages 27, 28 and 472 and U.S. Pat. Nos. 3,671,487 A, 3,723,373 A and 3,838,092 A). They can be prepared by known methods, for example by polymerizing tetrafluoroethylene in aqueous medium with a free-radical-forming catalyst, for example sodium, potassium or ammonium peroxodisulfate, at pressures from 7 to 71 kg/cm² and at temperatures from 0 to 200° C., preferably at temperatures from 20 to 100° C. Further details are described, for example, in U.S. Pat. No. 2,393,967 A.

Depending on the use form, the density of the fluorinated polyolefins can lie between 1.2 and 2.3 g/cm³, preferably 2.0 g/cm³ to 2.3 g/cm³, determined according to ISO 1183-1 (2019-09), and the average particle size between 0.05 and 1000 μm, determined by means of light microscopy or white light interferometry.

Suitable tetrafluoroethylene polymer powders are commercial products and are available by way of example from DuPont under the trade name Teflon®.

Particular preference is given to using polytetrafluoroethylene (PTFE) as such, but also in the form of a PTFE-containing composition, as fluorine-containing anti-drip agent. If a PTFE-containing composition is used, the minimum use amount thereof is preferably enough for at least 0.15% by weight, particularly preferably at least 0.25% by weight, of PTFE to be present in the overall composition. The PTFE-containing compositions include Hostaflon® TF2021 or PTFE blends such as Blendex® B449 (about 50% by weight of PTFE and about 50% by weight of SAN [from 80% by weight of styrene and 20% by weight of acrylonitrile]) from Chemtura. Very particular preference is given to using PTFE or a PTFE/SAN blend as fluorine-containing anti-drip agent; exceptionally preferably, the fluorine-containing anti-drip agent is PTFE or PTFE/SAN.

### Component E

The polycarbonate compositions according to the invention may contain one or more further additives different from components B, C and D, which are subsumed in the present case under “component E”.

Optionally (0% by weight) up to preferably 12% by weight, further preferably up to 5% by weight, further preferably still up to 3% by weight, in particular 0.1% by weight to 3% by weight, particularly preferably 0.2% by weight to 1% by weight, very particularly preferably 0.5% by weight to 1.0% by weight, of other customary additives (“further additives”) are present, these percentages by weight being based on the total weight of the composition. The group of further additives does not include any phosphorus-containing flame retardant according to component C. The group of further additives in particular also does not include any fluorine-containing anti-drip agent since this is already described as component D.

Such further additives, as are typically added to polycarbonates, are heat stabilizers, antioxidants, mold-release agents, UV absorbers, IR absorbers, impact modifiers, antistats, optical brighteners, light-scattering agents, hydrolysis stabilizers, transesterification stabilizers, (organic) dyes, (organic/inorganic) pigments, also comprising carbon black and titanium dioxide, compatibilizers and/or additives for laser marking, in particular in the amounts typical for polycarbonate-based compositions. Such additives are described, for example, in EP 0 839 623 A1, WO 96/15102 A1, EP 0 500 496 A1 or in “Plastics Additives Handbook”, Hans Zweifel, 5th Edition 2000, Hanser Verlag, Munich. These additives may be added individually or else in a mixture.

Further preferably present as further additives, where further additives are present at all, are solely one or more further additives selected from the group consisting of heat stabilizers, antioxidants, mold-release agents, organic dyes, organic pigments, inorganic pigments.

The further additive present is very particularly preferably at least one heat stabilizer, an antioxidant and/or a mold-release agent.

It will be appreciated that only such additives may be added, and only in such amounts, where they do not significantly negatively impact the effect according to the invention of high CTI in combination with good flame retardancy and preferably also do not lower the Vicat temperature, determined according to ISO 306:2014-3, VST Method B, below 105° C., further preferably below 108° C.

The compositions according to the invention may indeed contain, in addition to component C, further flame retardants, but are free of those selected from the group of alkali metal, alkaline earth metal or ammonium salts of aliphatic or aromatic sulfonic acid, sulfonamide or sulfonimide derivatives, and combinations thereof, with “derivatives” being understood to mean those compounds having a molecular structure that in place of a hydrogen atom or a functional group possesses a different atom or a different atom group or in which one or more atoms/atom groups has/have been removed. The parent compound is thus still recognizable.

Such flame retardants that are not present in compositions according to the invention are in particular one or more compounds selected from the group consisting of sodium or potassium perfluorobutanesulfate, sodium or potassium perfluoromethanesulfonate, sodium or potassium perfluorooctanesulfate, sodium or potassium 2,5-dichlorobenzenesulfate, sodium or potassium 2,4,5-trichlorobenzenesulfate, sodium or potassium diphenylsulfone sulfonate, sodium or potassium 2-formylbenzenesulfonate, sodium or potassium (N-benzenesulfonyl)benzenesulfonamide, or mixtures thereof, among these particularly preferably sodium or potassium perfluorobutanesulfate, sodium or potassium perfluorooctanesulfate, sodium or potassium diphenylsulfone sulfonate, or mixtures thereof, especially potassium perfluoro-1-butanesulfonate, which is commercially available, inter alia, as Bayowet® C4 from Lanxess, Leverkusen, Germany.

Additives that are particularly preferably present are mold-release agents, further preferably based on a fatty acid ester, further preferably still based on a stearic ester, especially preferably based on pentaerythritol. Particular preference is given to using pentaerythritol tetrastearate (PETS) and/or glycerol monostearate (GMS). If one or more mold-release agents are used, the amount is preferably up to 1.0% by weight (inclusive), further preferably 0.01% to 0.7% by weight, particularly preferably 0.2% to 0.60% by weight, based in each case on the overall composition.

Additives that are particularly preferably present are also heat stabilizers. The amount of heat stabilizer is preferably up to 0.20% by weight, further preferably 0.01% to 0.15% by weight, further preferably still 0.01% to 0.1% by weight, particularly preferably 0.025% to 0.09% by weight, based on the overall composition.

Suitable heat stabilizers are in particular phosphorus-based stabilizers selected from the group of the phosphates, phosphites, phosphonites, phosphines and mixtures thereof. Examples include triphenyl phosphite, diphenyl alkyl phosphite, phenyl dialkyl phosphite, tris(nonylphenyl) phosphite, trilauryl phosphite, trioctadecyl phosphite, distearyl pentaerythritol diphosphite, tris(2,4-di-tert-butylphenyl) phosphite (Irgafos® 168), diisodecyl pentaerythritol diphosphite, bis(2,4-di-tert-butylphenyl) pentaerythritol diphosphite, bis(2,4-dicumylphenyl) pentaerythritol diphosphite (Doverphos® S-9228), bis(2,6-di-tert-butyl-4-methylphenyl) pentaerythritol diphosphite, diisodecyloxy pentaerythritol diphosphite, bis(2,4-di-tert-butyl-6-methylphenyl) pentaerythritol diphosphite, bis(2,4,6-tris(tert-butylphenyl) pentaerythritol diphosphite, tristearyl sorbitol triphosphite, tetrakis(2,4-di-tert-butylphenyl)-4,4′-biphenylenediphosphonite, 6-isooctyloxy-2,4,8,10-tetra-tert-butyl-12H-dibenzo[d,g]-1,3,2-dioxaphosphocine, bis(2,4-di-tert-butyl-6-methylphenyl) methyl phosphite, bis(2,4-di-tert-butyl-6-methylphenyl) ethyl phosphite, 6-fluoro-2,4,8,10-tetra-tert-butyl-12-methyldibenzo[d,g]-1,3,2-dioxaphosphocine, 2,2′,2″-nitrilo[triethyltris(3,3′,5,5′-tetra-tert-butyl-1,1′-biphenyl-2,2′-diyl) phosphite], 2-ethylhexyl(3,3′,5,5′-tetra-tert-butyl-1,1′-biphenyl-2,2′-diyl) phosphite, 5-butyl-5-ethyl-2-(2,4,6-tri-tert-butylphenoxy)-1,3,2-dioxaphosphirane, bis(2,6-di-tert-butyl-4-methylphenyl)pentaerythritol diphosphite, triphenylphosphine (TPP), trialkylphenylphosphine, bisdiphenylphosphinoethane or a trinaphthylphosphine. They are used alone or in a mixture, for example Irganox® B900 (mixture of Irgafos® 168 and Irganox® 1076 (antioxidant) in a 4:1 ratio) or Doverphos® S-9228 with Irganox® B900 or Irganox® 1076. Especially preferably, triphenylphosphine (TPP), Irgafos® 168 or tris(nonylphenyl) phosphite, or mixtures thereof, are used.

It is also possible to use phenolic antioxidants such as alkylated monophenols, alkylated thioalkylphenols, hydroquinones and alkylated hydroquinones. Particular preference is given to using Irganox® 1010 (pentaerythritol 3-(4-hydroxy-3,5-di-tert-butylphenyl)propionate; CAS: 6683-19-8) and Irganox 1076® (octadecyl 3-(3,5-di-tert-butyl-4-hydroxyphenyl)propionate), preferably in amounts of 0.01%-0.5% by weight.

It is also possible to add sulfonic esters or alkyl phosphates, for example mono-, di- and/or trihexyl phosphate, triisooctyl phosphate and/or trinonyl phosphate, as transesterification inhibitors. The alkyl phosphate used is preferably triisooctyl phosphate (tris-2-ethylhexyl phosphate). It is also possible to use mixtures of various mono-, di- and trialkyl phosphates. Triisooctyl phosphate is preferably used in amounts from 0.003% by weight to 0.05% by weight, further preferably 0.005% by weight to 0.04% by weight and particularly preferably from 0.01% by weight to 0.03% by weight, based on the overall composition.

Examples of impact modifiers are: core-shell polymers such as ABS or MBS; olefin-acrylate copolymers such as the Elvaloy® types from DuPont or Paraloid® types from Dow; silicone acrylate rubbers such as the Metablen® types from Mitsubishi Rayon Co., Ltd. The compositions according to the invention already have an exceptional profile of properties without additional impact modifiers. Compositions according to the invention are therefore preferably free of impact modifiers.

Particularly preferably, no fillers are present in the compositions according to the invention.

Compositions that are preferred according to the invention consist of
A) at least 68% by weight of aromatic polycarbonate,
B) 4% by weight to 25% by weight of (meth)acrylate copolymer, wherein the (meth)acrylate copolymer comprises aromatic (meth)acrylate units b1 and methyl methacrylate units b2 in a weight ratio b1/b2 of (5% to 20% by weight)/(80% to 95% by weight), based on the total weight of the (meth)acrylate copolymer,
C) 2% by weight to 10% by weight of phosphorus-containing flame retardant,
D) 0.25% by weight to 2% by weight of fluorine-containing anti-drip agent containing polytetrafluoroethylene,
E) one or more further additives, selected from the group consisting of one or more mold-release agents, heat stabilizers, antioxidants, dyes, pigments, UV absorbers, IR absorbers, impact modifiers, antistats, optical brighteners, hydrolysis stabilizers, transesterification stabilizers, compatibilizers, additives for laser marking, and mixtures thereof,
wherein the % by weight figures are based on the overall composition and
wherein the ratio of the amount of (meth)acrylate copolymer in % by weight and the amount of phosphorus-containing flame retardant in % by weight is ≤2.5 and the ratio of the amount of (meth)acrylate copolymer in % by weight and the amount of polytetrafluoroethylene in % by weight is ≤20.

Compositions that are particularly preferred according to the invention consist of
A) at least 75% by weight of aromatic polycarbonate,
B) 5% by weight to 20% by weight of (meth)acrylate copolymer, wherein the (meth)acrylate copolymer comprises aromatic (meth)acrylate units b1 and methyl methacrylate units b2 in a weight ratio b1/b2 of (5% to 20% by weight)/(80% to 95% by weight), based on the total weight of the (meth)acrylate copolymer,
C) 2% by weight to 8% by weight of phosphorus-containing flame retardant,
D) 0.25% by weight to 2% by weight of fluorine-containing anti-drip agent containing polytetrafluoroethylene,
E) 0% to 5% by weight of one or more further additives, selected from the group consisting of one or more mold-release agents, heat stabilizers, antioxidants, dyes, pigments, UV absorbers, IR absorbers, impact modifiers, optical brighteners, hydrolysis stabilizers, transesterification stabilizers, compatibilizers, additives for laser marking, and mixtures thereof,
wherein the % by weight figures are based on the overall composition and
wherein the ratio of the amount of (meth)acrylate copolymer in % by weight and of the amount of phosphorus-containing flame retardant in % by weight is ≤2.5 and the ratio of the amount of (meth)acrylate copolymer in % by weight and the amount of polytetrafluoroethylene in % by weight is ≤20.

Compositions that are particularly preferred according to the invention consist of
A) at least 75% by weight of aromatic polycarbonate,
B) 5% by weight to 20% by weight of (meth)acrylate copolymer, wherein the (meth)acrylate copolymer contains aromatic (meth)acrylate units b1 in an amount of 5% to 20% by weight and methyl methacrylate units b2 in an amount of 80% to 95% by weight, based on the total weight of the (meth)acrylate copolymer,
C) 2% by weight to 8% by weight of phosphorus-containing flame retardant,
D) 0.25% by weight to 2% by weight of fluorine-containing anti-drip agent containing polytetrafluoroethylene,
E) 0% to 5% by weight of one or more further additives, selected from the group consisting of one or more mold-release agents, heat stabilizers, antioxidants, dyes, pigments, and mixtures thereof,
wherein the % by weight figures are based on the overall composition and
wherein the ratio of the amount of (meth)acrylate copolymer in % by weight and the amount of phosphorus-containing flame retardant in % by weight is ≤2.5 and the ratio of the amount of (meth)acrylate copolymer in % by weight and the amount of polytetrafluoroethylene in % by weight is ≤20.

The phosphorus-containing flame retardant present in this case is preferably either an organophosphate, in particular one of formula (12),

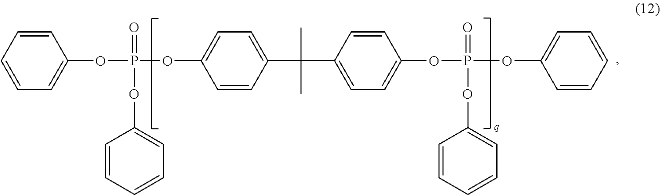

where q=1 to 20, in particular 1.0 to 1.2,
or a
phosphazene of formula (13g)

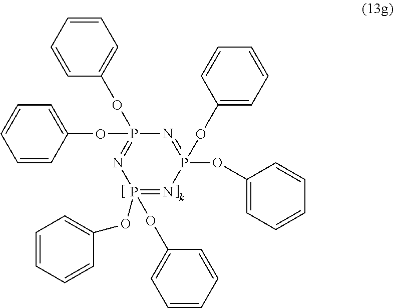

where k=1, 2 or 3, including mixtures thereof. It will be appreciated that this is preferably a mixture of various oligomers of this formula, since mixtures are commercially typically available. Very particularly preference is given to the phosphorus-containing flame retardant of one of formulae (12) or (13g), as defined above.

The polymer compositions according to the invention, containing the mixed components A, B, C, D and optionally E, may be prepared using powder premixes. It is also possible to use premixes of pellet materials or pellet materials and powders with the additions according to the invention. It is also possible to use premixes produced from solutions of the mixture components in suitable solvents, wherein homogenization is optionally effected in solution and the solvent is then removed. In particular, the additives referred to as component E of the compositions according to the invention can be introduced by known methods or in the form of a masterbatch. The use of masterbatches is preferred in particular for the introduction of additives and further constituents, with masterbatches based on the respective polymer matrix being used in particular.

The compositions according to the invention may for example be extruded. After extrusion, the extrudate may be cooled and comminuted. The combining and mixing of a premix in the melt may also be effected in the plasticizing unit of an injection molding machine. In this case, the melt is directly converted into a molded article in the subsequent step.

Compositions according to the invention are preferably used for the production of moldings for components from the EE sector, in particular for high-voltage switches, inverters, relays, electronic connectors, electrical connectors, circuit breakers, components for photovoltaic applications, electric motors, heat sinks, chargers or charging plugs for electric vehicles, electrical junction boxes, smart meter housings, miniature circuit breakers, busbars. The invention thus also provides moldings which are part of a corresponding component. “Part of a” here means that this may be an individual element of a complex product, of a component group, but likewise that it may be the entire element, as is conceivable for example in the case of “electronic connectors”.

A molding in the sense according to the invention is also an insulation layer made from the composition according to the invention. Such a layer can for example be provided on an inverter as a layer to protect against external influences. For inverters, standard insulation materials are those having a CTI of 600 V. The composition according to the invention may also be used as an insulation layer for other electrical components, for example transistors. The insulation layer creates for example a secure separation between the transistor and a metallic heat sink.

The component is preferably designed for an operating voltage of at least 400 V. It can however also be designed for a typical household operating voltage of 230 V±23 V in Europe, although lower distances between the electrical conductors can now be achieved. The molding is preferably used in such a way that the molding itself must have a comparative tracking index of at least 600 V, determined as described above.

The invention thus provides moldings consisting of, or comprising regions made from, compositions according to the invention, and also corresponding components comprising elements, i.e. moldings, which consist of compositions according to the invention or comprise regions consisting of compositions according to the invention.

The high comparative tracking index of the polycarbonate compositions according to the invention makes it possible, using the polycarbonate material, to achieve smaller distances between two electrical conductors of a component than was previously possible with the use of polycarbonate.

The invention thus also provides an EE component, comprising a first electrical conductor and a second electrical conductor at a first distance d1 and a second distance d2 with respect to one another,
which are connected via an element made from a thermoplastic composition according to the invention, the latter being in direct contact with the first electrical conductor and the second electrical conductor,
wherein the distance d1 is the shortest distance between the first electrical conductor and the second electrical conductor along the surface of the element made from the thermoplastic composition and
wherein the distance d2 is the shortest distance between the first electrical conductor and the second electrical conductor through the air,
wherein d2 is selected in such a way that at the respective operating voltage a sparkover through the air is prevented and
wherein d1, at the operating voltage U listed below, is:
d1i (0 V≤U≤250 V): 1.3 mm to <2.5 mm
d1ii (250 V<U≤500 V)=2.5 mm to <5.0 mm
d1iii (500 V<U≤1000 V)=5.0 mm to <10.0 mm.

Such small lower limits for the distances between the electrical conductors are achievable only with a material having at least a CTI of 600 V. Even the upper range of these small distance ranges can only be achieved when the material used has at least a CTI of 400 V.

Even the distance ranges detailed below are thus achievable at the specified operating voltages only when the material has a CTI of at least 400 V:
d1i (0 V≤U≤250 V): 1.8 mm to <2.5 mm
d1ii (250 V<U≤500 V)=3.6 mm to <5.0 mm
d1iii (500 V<U≤1000 V)=7.1 mm to <10.0 mm.

Particularly preferably, d1 when a material having a CTI of 600 V is used, as described as part of the invention, at the listed operating voltage is:
d1i (0 V≤U≤250 V): 1.3 mm to <1.8 mm,
d1ii (250 V<U≤500 V)=2.5 mm to <3.6 mm,
d1iii (500 V<U≤1000 V)=5.0 mm to <7.1 mm, distances that are not achievable even with a material with a CTI of 400 V or 450 V, but require a CTI of 600 V.

It is thus possible to achieve EE components with polycarbonate material between two electrical conductors having smaller distances than considered possible to date.

The selection of d2 is within the ability of those skilled in the art. Preferably, d2 is at least 1.2 mm.

“Element made from a thermoplastic composition according to the invention” here means that an element is present which consists of a thermoplastic composition according to the invention.

It is well known that the degree of soiling affects the electrical conductivity. The distances d1 and d2 mentioned are usable in practice in components in which, for example due to structural shielding, an IP6K9K degree of protection according to ISO 20653:2013-02 is adhered to.

Thermoplastic compositions that are preferred according to the invention belong to insulating material group I (600 V≤CTI), classified according to DIN EN 60664-1.

The EE component according to the invention, because of the high comparative tracking index of the material used, is preferably used for EE assemblies that are designed for an operating voltage of at least 400 V, possibly even 600 V. The invention thus also provides corresponding EE assemblies.

Various embodiments of the present invention are described below:

1. A thermoplastic composition, containing
A) at least 68% by weight of aromatic polycarbonate,
B) 4% by weight to 25% by weight of (meth)acrylate copolymer, wherein the (meth)acrylate copolymer comprises aromatic (meth)acrylate units b1 and methyl methacrylate units b2 in a weight ratio b1/b2 of (5% to 20% by weight)/(80% to 95% by weight), based on the total weight of the (meth)acrylate copolymer,
C) 2% by weight to 10% by weight of phosphorus-containing flame retardant,
D) 0.25% by weight to 2% by weight of fluorine-containing anti-drip agent containing polytetrafluoroethylene,
E) optionally one or more further additives, selected from the group consisting of one or more mold-release agents, heat stabilizers, antioxidants, dyes, pigments, UV absorbers, IR absorbers, impact modifiers, antistats, optical brighteners, hydrolysis stabilizers, transesterification stabilizers, compatibilizers, additives for laser marking, and mixtures thereof,
wherein the % by weight figures are based on the overall composition and
wherein the ratio of the amount of (meth)acrylate copolymer in % by weight and the amount of phosphorus-containing flame retardant in % by weight is ≤2.5 and the ratio of the amount of (meth)acrylate copolymer in % by weight and the amount of polytetrafluoroethylene in % by weight is ≤20 and
wherein the thermoplastic composition is free of flame retardants selected from the group of alkali metal, alkaline earth metal and ammonium salts of aliphatic or aromatic sulfonic acid, sulfonamide and sulfonimide derivatives.

2. The thermoplastic composition according to embodiment 1, wherein the ratio of the amount of (meth)acrylate copolymer in % by weight and the amount of polytetrafluoroethylene in % by weight is ≤10.

3. The thermoplastic composition according to embodiment 1 or 2, wherein the phosphorus-containing flame retardant is an organophosphate, a phosphazene or a mixture of these.

4. The thermoplastic composition according to any of the preceding embodiments, wherein, as phosphorus-containing flame retardant, an organophosphate of formula (11) is present

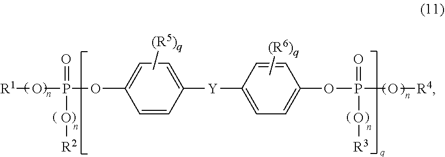

in which
R¹, R², R³ and R⁴ are each independently a linear or branched C₁- to C₅-alkyl radical and/or optionally linear- or branched-alkyl-substituted C₅- to C₆-cycloalkyl radical, C₆- to C₁₀-aryl radical or C₇- to C₁₂-aralkyl radical,
n is independently 0 or 1,
q is independently 0, 1, 2, 3 or 4,
N is a number between 1 and 30,
R₅ and R₆ are independently linear or branched C₁- to C₄-alkyl radical, preferably methyl radical, and
Y is linear or branched C₁- to C₇-alkylidene, a linear or branched C₁- to C₇-alkylene radical, C₅- to C₁₂-cycloalkylene radical, C₅- to C₁₂-cycloalkylidene radical, —O—, —S—, —SO—, SO₂ or —CO—.

5. The thermoplastic composition according to any of the preceding embodiments, wherein, as phosphorus-containing flame retardant, phosphazene of formula (13g) is present

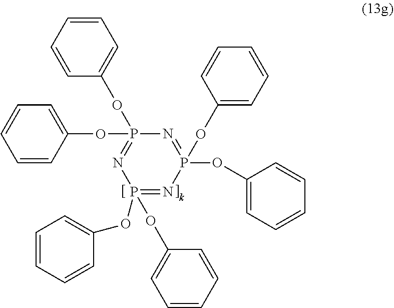

where k=1, 2 or 3, including mixtures thereof.

6. The thermoplastic composition according to any of the preceding embodiments, wherein the composition contains 5% to 20% by weight of (meth)acrylate copolymer.

7. The thermoplastic composition according to any of the preceding embodiments, wherein the composition contains 0.3% by weight to 1.0% by weight of mold-release agent.

8. The thermoplastic composition according to any of the preceding embodiments, wherein the composition contains a total of 0.02% to 0.15% by weight of heat stabilizer and/or antioxidant.

9. The thermoplastic composition according to any of the preceding embodiments, wherein the amount of phosphorus-containing flame retardant is 2% to 8% by weight.

10. The thermoplastic composition according to any of the preceding embodiments, wherein component B has a weight-average molecular weight, determined by means of gel permeation chromatography in tetrahydrofuran with PMMA calibration, of 5000 to 300 000 g/mol.

11. The thermoplastic composition according to any of the preceding embodiments, wherein component B has a weight-average molecular weight, determined by means of gel permeation chromatography in tetrahydrofuran with PMMA calibration, of 10 000 to 25 000 g/mol.

12. The thermoplastic composition according to any of the preceding embodiments, wherein the aromatic (meth)acrylate is phenyl (meth)acrylate and/or benzyl (meth)acrylate.

13. The thermoplastic composition according to any of the preceding embodiments, wherein the thermoplastic composition contains, in addition to components A, B, C and D, as component E, solely one or more heat stabilizers, antioxidants, mold-release agents, dyes, pigments, and mixtures thereof.

14. A molding consisting of, or comprising a region made from, a thermoplastic composition according to any of the preceding embodiments.

15. The molding according to embodiment 14, wherein the molding is part of a high-voltage switch, inverter, relay, electronic connector, electrical connector, circuit breaker, a photovoltaic system, an electric motor, a heat sink, a charger for electric vehicles, an electrical junction box, a smart meter housing, a miniature circuit breaker, a busbar.

16. The molding according to embodiment 14 or embodiment 15, wherein the molding is part of an EE component that is designed for an operating voltage of at least 375 V.

17. The molding according to any of embodiments 14 to 16, wherein the molding is part of an EE component that is designed for an operating voltage of at least 400 V.

18. The molding according to any of embodiments 14 to 17, wherein the molding is part of an EE component that is designed for an operating voltage of at least 500 V.

19. The molding according to any of embodiments 14 to 18, wherein the molding is part of an EE component that is designed for an operating voltage of at least 600 V.

20. An EE component, comprising
a first electrical conductor and a second electrical conductor at a first distance d1 and a second distance d2 with respect to one another,
which are connected via an element made from a thermoplastic composition according to any of embodiments 1 to 13, which is in direct contact with the first electrical conductor and the second electrical conductor,
wherein the distance d1 is the shortest distance between the first electrical conductor and the second electrical conductor along the surface of the element made from the thermoplastic composition and
wherein the distance d2 is the shortest distance between the first electrical conductor and the second electrical conductor through the air,
wherein d2 is selected in such a way that at the respective operating voltage a sparkover through the air is prevented and
wherein d1, at the operating voltage U listed below, is:
d1i (0 V≤U≤250 V): 1.3 mm to <2.5 mm
d1ii (250 V<U≤500 V)=2.5 mm to <5.0 mm
d1iii (500 V<U≤1000 V)=5.0 mm to <10.0 mm.

21. The EE component according to embodiment 20, wherein d1, at the operating voltage U listed below, is:
d1i (0 V≤U≤250 V): 1.3 mm to <1.8 mm,
d1ii (250 V<U≤500 V)=2.5 mm to <3.6 mm,
d1iii (500 V<U≤1000 V)=5.0 mm to <7.1 mm.

22. The EE component according to either of embodiments 20 and 21, wherein d2 is ≥1.2 mm.

23. The EE component according to any of embodiments 20 to 22, with an IP6K9K degree of protection according to ISO 20653:2013-02.

24. The EE component according to any of embodiments 20 to 23, designed for an operating voltage of at least 400 V, preferably of at least 500 V, particularly preferably of at least 600 V.

25. The EE component according to any of embodiments 20 to 24, wherein the element made from a thermoplastic composition according to any of embodiments 1 to 13 is a molding according to any of embodiments 14 to 19.

26. The EE component according to any of embodiments 20 to 25 wherein the EE component is part of a high-voltage switch, inverter, relay, electronic connector, electrical connector, circuit breaker, a photovoltaic system, an electric motor, a heat sink, a charger or charging plug for electric vehicles, an electrical junction box, a smart meter housing, a miniature circuit breaker, a busbar.

27. The use of the combination of 4% to 25% by weight of (meth)acrylate copolymer, wherein the (meth)acrylate copolymer comprises aromatic (meth)acrylate units b1 and methyl methacrylate units b2 in a weight ratio b1/b2 of (5% to 20% by weight)/(80% to 95% by weight), based on the total weight of the (meth)acrylate copolymer, 0.25% to 2% by weight of fluorine-containing anti-drip agent containing polytetrafluoroethylene, and 2% to 10% by weight, preferably 2% to 8% by weight, of phosphorus-containing flame retardant, wherein the % by weight indications are based on the resulting overall composition and
wherein the ratio of the amount of (meth)acrylate copolymer in % by weight and the amount of phosphorus-containing flame retardant in % by weight is ≤2.5 and the ratio of the amount of (meth)acrylate copolymer in % by weight and the amount of polytetrafluoroethylene in % by weight is ≤20, for attaining a CTI of 600 V and a UL94 V0 classification at 2 mm in a thermoplastic, polycarbonate-based composition.

28. An EE assembly, comprising an EE component according to any of embodiments 20 to 26, wherein the EE assembly has an IP6K9K degree of protection according to ISO 20653:2013-02.

29. The thermoplastic composition according to any of embodiments 1 to 13, the molding according to any of embodiments 14 to 19, the EE component according to any of embodiments 20 to 26, the use according to embodiment 27 or the EE assembly according to embodiment 28, wherein the aromatic polycarbonate is bisphenol A-based homopolycarbonate.

### Examples

### 1. Description of Raw Materials and Test Methods

### a) Raw Materials

Component A-1: Linear polycarbonate based on bisphenol A having a melt volume flow rate of 12 cm³/(10 min) (according to ISO 1133:2012-03, at a test temperature of 300° C. and with 1.2 kg load) containing as component E-3 250 ppm (=0.025% by weight, based on the total weight of component A) of triphenylphosphine heat stabilizer.
Component A-2: Linear polycarbonate based on bisphenol A having a melt volume flow rate of 6 cm³/(10 min) (according to ISO 1133:2012-03, at a test temperature of 300° C. and with 1.2 kg load).
Component B-1: (Meth)acrylate copolymer, trade name Metablen H-881 from Mitsubishi Rayon, containing approx. 10% by weight of aromatic acrylate component.
Component C-1: Organophosphate of formula (12) with q=1.0-1.2. Bisphenol A bis(diphenyl phosphate) from Adeka.
Component C-2: Rabitle FP110 phenoxycyclophosphazene from Fushimi Pharmaceutical, Japan, formula (13g), with a trimer proportion (k=1) of approximately 68 mol %.
Component C-3*: Potassium perfluoro-1-butanesulfonate, commercially available as Bayowet® C₄ from Lanxess AG, Leverkusen, Germany, CAS no. 29420-49-3.
Component D-1: ADS5000 SAN-encapsulated polytetrafluoroethylene (approx. 50% by weight PTFE (fluorine-containing anti-drip agent) and approx. 50% by weight SAN) from Chemical Innovation Co., Ltd. Thailand.
Component D-2: Teflon CFP6000X polytetrafluoroethylene from Chemours Netherlands B.V.
Component E-1: Mold-release agent. Pentaerythritol tetrastearate, commercially available as Loxiol VPG 861 from Emery Oleochemicals Group.
Component E-2: Mixture of heat stabilizer and antioxidant. Irganox® B900 from BASF (mixture of Irgafos® 168 (tris(2,4-di-tert-butylphenyl) phosphite) and Irganox® 1076 (octadecyl 3-(3,5-di-tert-butyl-4-hydroxyphenyl)propionate) in a 4:1 ratio by weight).

### b) Test Methods

### Comparative Tracking Index (CTI):

In order to determine the comparative tracking index, the compositions described here were tested according to the rapid test method based on IEC 60112:2009. To this end, a 0.1% ammonium chloride test solution (395 ohm*cm resistance) was applied dropwise, between two neighboring electrodes spaced apart by 4 mm, to the surface of test specimens of dimensions 60 mm×40 mm×4 mm at a time interval of 30 s. A test voltage was applied between the electrodes and was varied over the course of the test. The first test specimen was tested at a starting voltage of 300 V or 350 V. A maximum of 50 drops (one drop every 30 s) in total were applied per voltage as long as no tracking current>0.5 A over 2 s occurred or the sample burned. After 50 drops, the voltage was increased by 50 V and a new test specimen was tested at this higher voltage, according to the procedure described above. This process was continued until either 600 V was reached or a tracking current or burning occurred. If one of the above-mentioned effects already occurred with fewer than 50 drops, the voltage was reduced by 25 V and a new test specimen was tested at this lower voltage. The voltage was reduced until the test was passed with 50 drops without tracking current or burning. This procedure was therefore used to determine the maximum possible voltage at which a composition was able to withstand 50 drops of the test solution without occurrence of a tracking current. Lastly, four further test specimens were tested at the determined maximum voltage with 50 drops each for confirmation. This confirmed value is reported as the CTI in the examples. A 100-drop value was not determined, hence “rapid test method based on” the specified standard.

### PTI (Proof Tracking Index):

The PTI is tested based on IEC 60112:2009, modified as described below. To this end, a 0.1% ammonium chloride test solution (395 ohm*cm resistance) was applied dropwise, between two neighboring electrodes spaced apart by 4 mm, to the surface of test specimens of dimensions 60 mm×40 mm×4 mm at a time interval of 30 s. In contrast to the CTI testing, in the PTI testing a fixed test voltage is applied between the electrodes and a total of 5 test specimens are tested at the respective voltage. A maximum of 50 drops (one drop every 30 s) in total were applied per test specimen as long as no tracking current>0.5 A over 2 s occurred or the sample burned.

### Flame Retardancy:

The flame retardancy of the polycarbonate compositions was tested according to Underwriters Laboratories method UL 94 V in a thickness of 2 mm. The specified flammability class results from the individual tests after 48 h and 168 h of standard conditioning.

Various fire classes are assigned depending on the behavior of the test specimens. This includes the time until the flame is extinguished, resistance to dripping, or whether a material produces burning drips. The classes determined hereafter are designated V0, V1 and V2 and are ascertained on the basis of a total of five tested test specimens.
V0: The test specimen, positioned with its longitudinal axis 1800 (vertical) to the flame, has an average afterflame time after removal of the flame of not more than 10 s and does not produce any dripping plastic particles that ignite cotton wool located under the test specimen. The total afterflame time of five test specimens, in each case with two times flame application, is at most 50 s.
V1: In contrast to V0, the average maximum afterflame time here is <30 s, and here too no dripping particles or ignition of the cotton wool are permitted. The total afterflame time of five test specimens, in each case with two times flame application, is <250 s.
V2: In contrast to V0 and V1, dripping plastic particles that ignite the cotton wool are formed in this classification. The individual afterflame times are <30 s and the total afterflame time of 5 test specimens, in each case with two times flame application, is <250 s.
f.: The test does not deliver a flame retardancy classification if the afterflame times are exceeded.

### Heat Distortion Resistance:

The heat distortion resistance of the compositions was determined on the basis of the Vicat softening temperature (method B, test force 50 N, heating rate 50 K/h) on test specimens having the dimensions 80 mm×10 mm×4 mm according to ISO 306:2014-3.

### 2. Production of the Test Specimens

The compositions were prepared on a 25 mm twin-screw extruder from Coperion with a throughput of 20 kg/h. The temperatures of the polymer melt in the extruder were between 260-280° C. with an average screw speed of 225 rpm.

The test specimens having the dimensions 60 mm×40 mm×4 mm were produced from the molding compounds using standard injection molding methods at a melt temperature of 280° C. and a mold temperature of 80° C.

### 3. Results

In the tables below, “n.t.” means “not tested” and “f.” means “failed”. The “*” means “taken from UL Yellow Card”.

TABLE 1

| Component | | V-1 | V-2 | V-3 | E-4 | E-5 | E-6 |
|---|---|---|---|---|---|---|---|
| A-1 | % by wt. | 100 | 99.4 | 89.4 | 81.9 | 79.9 | 75.9 |
| A-2 | % by wt. | | | 5 | 10.0 | 10.0 | 10.0 |
| B-1 | % by wt. | | | 5 | 5 | 5 | 5 |
| C-1 | % by wt. | | | | 2 | 4 | 8 |
| C-2 | % by wt. | | | | | | |
| D-1 | % by wt. | | | | 0.5 | 0.5 | 0.5 |
| E-1 | % by wt. | | 0.5 | 0.5 | 0.5 | 0.5 | 0.5 |
| E-2 | % by wt. | | 0.1 | 0.1 | 0.1 | 0.1 | 0.1 |
| CTI | V | 250 | 300 | 600 | 600 | 600 | 600 |
| PTI at 300 V | Number | n.t. | n.t. | 5/5 | n.t. | 5/5 | n.t. |
| | passed | | | | | | |
| PTI at 350 V | Number | n.t. | n.t. | 5/5 | n.t. | 5/5 | n.t. |
| | passed | | | | | | |
| PTI at 600 V | Number | n.t | n.t | 5/5 | 5/5 | 5/5 | 5/5 |
| | passed | | | | | | |
| UL94 (class) | 2 mm | V2* | V2 | V2 | V0 | V0 | V0 |
| Vicat | ° C. | 144 | 141 | 138 | 128 | 123 | 119 |
| temperature | | | | | | | |

n.t.: not tested,
f.: failed

Tables 1-3 comprise polycarbonate compositions having 5-20% by weight of polymethacrylate copolymer B-1. In the case of the polycarbonate with intrinsically poor comparative tracking index, even small amounts of component B-1 surprisingly result in a significant improvement in the comparative tracking index (cf. V-2 with V-3). The fact that this composition has a robust comparative tracking index is demonstrated by the passed PTI tests in the medium voltage range of 300-350 V. This range is particularly critical and is usually the reason for a failure in the CTI test. If a material is able to successfully pass this voltage range, then the probability of a high CTI of e.g. 600 V is very high. A V0 classification according to UL94 at 2 mm can however only be achieved by addition of additional flame retardant and anti-drip agent (E-4 to E-6). Even greater amounts of the polymethyl methacrylate copolymer B-1 also have a positive effect on the CTI (see Table 2), it being clearly apparent here from Comparative Examples V-8 and V-9 that the choice of the flame retardant is important. Even in very small amounts, inorganic sulfonate (component C-3*) results in a failure of the material in the CTI test. Even greater amounts of otherwise well-suited phosphorus-based flame retardants (components C-1 and C-2) result in a negative influence on the CTI (see V-17 and V-22). It is also clearly apparent from the results in Table 2 that without addition of anti-drip agent, a V0 classification according to UL94 cannot be achieved (see V-11, V-15, V-18, V-20), not even with high amounts of flame retardant (cf. V-17 and V-22). The optimal amount of anti-drip agent depends on the amount of the polymethyl methacrylate copolymer B-1. Greater amounts of polymethyl methacrylate copolymer generally require greater amounts of PTFE-containing anti-drip agent (cf. e.g. E-5 with V-12 and E-13). With 10% by weight of PMMA component, 1% by weight of PTFE (component D-2) or correspondingly 2% by weight of 50:50 PTFE:SAN masterbatch D-1 is needed for a V0 classification (see E-13 to E-21). The optimal amount of flame retardant is above 2% by weight and, as described above, below 12% by weight, with the heat distortion resistance decreasing as the amount increases. With amounts of the polymethyl methacrylate copolymer in the range of 20% by weight, it becomes increasingly difficult to make the composition sufficiently flame-retardant, which has a clear effect on the heat distortion resistance (see Table 3).

TABLE 2

| Component | | V-7 | V-8 | V-9 | V-10 | V-11 | V-12 | E-13 | E-14 | V-15 | E-16 | V-17 | V-18 | E-19 | V-20 | E-21 | V-22 |
|---|---|---|---|---|---|---|---|---|---|---|---|---|---|---|---|---|---|
| A-1 | % by wt. | 84.4 | 84.35 | 84.31 | 75.4 | 80.4 | 79.9 | 78.4 | 79.4 | 76.4 | 75.4 | 72.4 | 75.4 | 79.4 | 71.4 | 75.4 | 67.4 |
| A-2 | % by wt. | 5 | 5 | 5 | 10 | 5 | 5 | 5 | 5 | 5 | 5 | 5 | 10 | 5 | 10 | 5 | 10 |
| B-1 | % by wt. | 10 | 10 | 10 | 10 | 10 | 10 | 10 | 10 | 10 | 10 | 10 | 10 | 10 | 10 | 10 | 10 |
| C-1 | % by wt. | | | | 2 | 4 | 4 | 4 | 4 | 8 | 8 | 12 | | | | | |
| C-2 | % by wt. | | | | | | | | | | | | 4 | 4 | 8 | 8 | 12 |
| C-3* | % by wt. | | 0.05 | 0.09 | | | | | | | | | | | | | |
| D- | % by wt. | | | | 2 | | 0.5 | 2 | | | | | | | | | |
| D-2 | % by wt. | | | | | | | | 1 | | 1 | | | 1 | | 1 | |
| E-1 | % by wt. | 0.5 | 0.5 | 0.5 | 0.5 | 0.5 | 0.5 | 0.5 | 0.5 | 0.5 | 0.5 | 0.5 | 0.5 | 0.5 | 0.5 | 0.5 | 0.5 |
| E-2 | % by wt. | 0.1 | 0.1 | 0.1 | 0.1 | 0.1 | 0.1 | 0.1 | 0.1 | 0.1 | 0.1 | 0.1 | 0.1 | 0.1 | 0.1 | 0.1 | 0.1 |
| CTI | V | 600 | 225 | 225 | 600 | 600 | 600 | 600 | 600 | 600 | 600 | 275 | 600 | 600 | 600 | 600 | 250 |
| PTI at 300 V | Number | 5/5 | n.t. | n.t. | n.t. | 5/5 | n.t. | 5/5 | n.t. | n.t. | n.t. | n.t. | 5/5 | n.t. | n.t. | n.t. | n.t. |
| | passed | | | | | | | | | | | | | | | | |
| PTI at 350 V | Number | 5/5 | n.t. | n.t. | n.t. | 5/5 | n.t. | 5/5 | n.t. | n.t. | n.t. | n.t. | 5/5 | n.t. | n.t. | n.t. | n.t. |
| | passed | | | | | | | | | | | | | | | | |
| PTI at 600 V | Number | 5/5 | n.t. | n.t. | 5/5 | 5/5 | 5/5 | 5/5 | 5/5 | 5/5 | 5/5 | 5/5 | 5/5 | 5/5 | 5/5 | 5/5 | n.t. |
| | passed | | | | | | | | | | | | | | | | |
| UL94 (class) | 2 mm | V2 | f. | f. | V2 | V2 | V2 | V0 | V0 | V2 | V0 | V2 | V2 | V0 | V2 | V0 | V2 |
| Vicat | | 134 | 133 | 133 | 126 | 121 | 120 | 122 | 122 | 111 | 109 | 101 | 126 | 124 | 117 | 113 | 109 |
| temperature | | | | | | | | | | | | | | | | | |

TABLE 3

| Component | | V-23 | V-24 | V-25 | E-26 |
|---|---|---|---|---|---|
| A-1 | % by wt. | 80 | 63.4 | 74.4 | 64.4 |
| A-2 | % by wt. | | 10.0 | 5 | 5 |
| B-1 | % by wt. | 20 | 20 | 20 | 20 |
| C-1 | % by wt. | | | | |
| C-2 | % by wt. | | 4 | | 8 |
| D-1 | % by wt. | | 2 | | 2 |
| E-1 | % by wt. | | 0.5 | 0.5 | 0.5 |
| E-2 | % by wt. | | 0.1 | 0.1 | 0.1 |
| CTI | V | 600 | 600 | 600 | 600 |
| PTI at 300 V | Number | n.t. | n.t. | 5/5 | 5/5 |
| | passed | | | | |
| PTI at 350 V | Number | n.t. | n.t. | 5/5 | 5/5 |
| | passed | | | | |
| PTI at 600 V | Number | 5/5 | 5/5 | 5/5 | 5/5 |
| | passed | | | | |
| UL94 (total) | 2 mm | n.t. | V2 | f. | V0 |
| Vicat | ° C. | 129 | 114 | 129 | 110 |
| temperature | | | | | |

n.t.: not tested,
f.: failed

1. A thermoplastic composition containing
A) at least 68% by weight of aromatic polycarbonate,
B) 4% by weight to 25% by weight of (meth)acrylate copolymer, wherein the (meth)acrylate copolymer comprises aromatic (meth)acrylate units b1 and methyl methacrylate units b2 in a weight ratio b1/b2 of (5% to 20% by weight)/(80% to 95% by weight), based on the total weight of the (meth)acrylate copolymer,
C) 2% by weight to 10% by weight of phosphorus-containing flame retardant,
D) 0.25% by weight to 2% by weight of fluorine-containing anti-drip agent containing polytetrafluoroethylene,
wherein the % by weight figures are based on the overall composition and
wherein the ratio of the amount of (meth)acrylate copolymer in % by weight and the amount of phosphorus-containing flame retardant in % by weight is ≤2.5 and the ratio of the amount of (meth)acrylate copolymer in % by weight and the amount of polytetrafluoroethylene in % by weight is ≤20 and
wherein the thermoplastic composition is free of flame retardants selected from the group of alkali metal, alkaline earth metal and ammonium salts of aliphatic or aromatic sulfonic acid, sulfonamide and sulfonimide derivatives.

2. The thermoplastic composition as claimed in claim 1, wherein the amount of phosphorus-containing flame retardant is 2% by weight to 8% by weight.

3. The thermoplastic composition as claimed in claim 1, wherein the aromatic polycarbonate is bisphenol A homopolycarbonate.

4. The thermoplastic composition as claimed in claim 1, wherein the composition contains 5% to 20% by weight of (meth)acrylate copolymer.

5. The thermoplastic composition as claimed in claim 1, wherein the phosphorus-containing flame retardant is an organophosphate, a phosphazene or a mixture of these.

6. The thermoplastic composition as claimed in claim 1, wherein, as phosphorus-containing flame retardant, phosphazene of formula (13g) is present 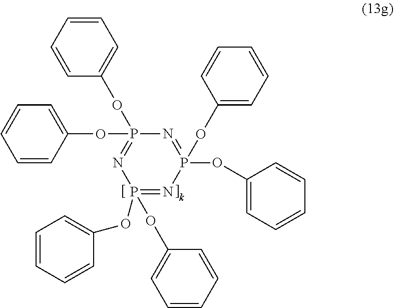
where k=1, 2 or 3, including mixtures thereof.

7. The thermoplastic composition as claimed in claim 1, wherein, as phosphorus-containing flame retardant, an organophosphate of formula (11) is present 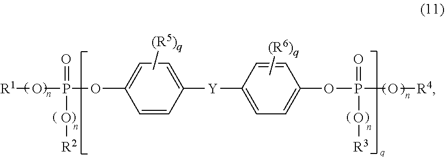
in which
R¹, R², R³ and R⁴ are each independently a linear or branched C₁- to C₅-alkyl radical and/or optionally linear- or branched-alkyl-substituted C₅- to C₆-cycloalkyl radical, C₆- to C₁₀-aryl radical or C₇- to C₁₂-aralkyl radical,
n is independently 0 or 1,
q is independently 0, 1, 2, 3 or 4,
N is a number between 1 and 30,
R₅ and R₆ are independently linear or branched C₁- to C₄-alkyl radical, and
Y is linear or branched C₁- to C₇-alkylidene, a linear or branched C₁- to C₇-alkylene radical, C₅- to C₁₂-cycloalkylene radical, C₅- to C₁₂-cycloalkylidene radical, —O—, —S—, —SO—, SO₂ or —CO—.

8. The thermoplastic composition as claimed in claim 1, wherein the composition consists of components A to D and optionally a component E containing
E) one or more further additives, selected from the group consisting of one or more mold-release agents, heat stabilizers, antioxidants, dyes, pigments, UV absorbers, IR absorbers, impact modifiers, antistats, optical brighteners, hydrolysis stabilizers, transesterification stabilizers, compatibilizers, additives for laser marking, and mixtures thereof.

9. The thermoplastic composition as claimed in claim 1, wherein the thermoplastic composition also contains, in addition to components A, B, C and D, solely one or more heat stabilizers, antioxidants, mold-release agents, dyes, pigments, and mixtures thereof.

10. A molding consisting of, or comprising a region made from, a thermoplastic composition as claimed in claim 1.

11. The molding as claimed in claim 10, wherein the molding is part of a high-voltage switch, inverter, relay, electronic connector, electrical connector, circuit breaker, a photovoltaic system, an electric motor, a heat sink, a charger or charging plug for electric vehicles, an electrical junction box, a smart meter housing, a miniature circuit breaker, or a busbar.

12. An EE component, comprising a molding as claimed in claim 10.

13. The EE component as claimed in claim 12, comprising
a first electrical conductor and a second electrical conductor at a first distance d1 and a second distance d2 with respect to one another,
which are connected via the thermoplastic composition,
which is in direct contact with the first electrical conductor and the second electrical conductor,
wherein the distance d1 is the shortest distance between the first electrical conductor and the second electrical conductor along the surface of the thermoplastic material M and
wherein the distance d2 is the shortest distance between the first electrical conductor and the second electrical conductor through the air, wherein d2 is selected in such a way that at the respective operating voltage a sparkover through the air is prevented,
wherein d1, at the operating voltage U listed below, is:
d1i (0 V≤U≤250 V): 1.3 mm to <2.5 mm
d1ii (250 V<U≤500 V)=2.5 mm to <5.0 mm
d1iii (500 V<U≤1000 V)=5.0 mm to <10.0 mm.

14. A method for attaining a CTI, determined based on IEC 60112:2009, of 600 V and a UL94 V0 classification at 2 mm in a thermoplastic, aromatic polycarbonate-based composition by providing a combination of 4% by weight to 25% by weight of (meth)acrylate copolymer, wherein the (meth)acrylate copolymer comprises aromatic (meth)acrylate units b1 and methyl methacrylate units b2 in a weight ratio b1/b2 of (5% to 20% by weight)/(80% to 95% by weight), based on the total weight of the (meth)acrylate copolymer,
2% by weight to 10% by weight of phosphorus-containing flame retardant,
0.25% by weight to 2% by weight of fluorine-containing anti-drip agent containing polytetrafluoroethylene,
wherein the % by weight figures are based on the resulting overall composition and
wherein the ratio of the amount of (meth)acrylate copolymer in % by weight and the amount of phosphorus-containing flame retardant in % by weight is ≤2.5 and the ratio of the amount of (meth)acrylate copolymer in % by weight and the amount of polytetrafluoroethylene in % by weight is ≤20.

15. An EE component, comprising a layer made from a thermoplastic composition as claimed in claim 1.
